(19) United States
(12) Patent Application Publication
(10) Pub. No.: US 2024/0386353 A1
(43) Pub. Date: Nov. 21, 2024

(54) SYSTEMS AND METHODS FOR HYBRID INPUT MODELING

(71) Applicant: Walmart Apollo, LLC, Bentonville, AR (US)

(72) Inventors: Shantala Narasimha Murthy Manchenahally, Basavanagudi (IN); Ankit Shukla, Bangalore (IN); Kedarnath Reddy Vudayagiri, Andhra Pradesh (IN); Ankit Ajit Jain, Bangalore (IN)

(21) Appl. No.: 18/318,138

(22) Filed: May 16, 2023

(51) Int. Cl. G06Q 10/0637

(52) U.S. Cl. CPC G06Q 10/06375

(57) ABSTRACT

Systems and methods of generating inputs for simulation of a target system are disclosed. A set of input generation parameters are received and a simulation time period for a simulation of a target system is determined based on the set of input generation parameters. One of a plurality of input generation subsystems is selected for the time period. Each of the plurality of input generation subsystems is configured to generate a set of simulation inputs for one of a plurality of defined time periods. At least one of the plurality of input generation subsystems is configured to generate a stochastic set of simulation inputs. The set of simulation inputs is generated by implementing a input generation process defined by the selected one of the plurality of input generation subsystems. A statistical simulation of the target system is implemented based on the set of simulation inputs.

### TECHNICAL FIELD

This application relates generally to simulation platforms, and more particularly, to simulation platforms utilizing stochastic inputs.

### BACKGROUND

Simulation platforms enable understanding of complex systems, such as supply chains. Simulation platforms rely on input data for generating accurate and useful simulations. Some current systems rely on traditional statistical methods to generate predetermined distributions for use in simulation platform. Such systems are not able to model complex multivariate or correlated inputs required for modeling of complex systems.

As one example, modeling of a supply chain for a modern retailer requires modeling of multiple complex sub-domains encompassing both brick-and-mortar supply chain systems or domains and online fulfillment supply chain systems or domains. Some current systems use traditional resource-intensive statistical models to generate a set of predetermined distributions. Predetermined distributions are selected based on the fit between the predetermined distributions and data related to the system. However, predetermined distributions generated using traditional statistical methods are not able to model the complex nature of the underlying systems, often relying on simplified assumptions about the system or correlation between variables to make the statistical solutions tractable. Similarly, fitting of predetermined distributions relies on stationary assumptions with univariate distributions that fails to capture multivariate or correlated inputs.

### SUMMARY

In various embodiments, a system configured to simulate a target system is disclosed. The system includes a non-transitory memory and a processor communicatively coupled to the non-transitory memory. The processor is configured to read a set of instructions to receive a set of input generation parameters, determine a simulation time period for a simulation of the target system based on the set of input generation parameters, and select one of a plurality of input generation subsystems for the simulation time period. The simulation time period is one of a plurality of defined time periods and each of the plurality of input generation subsystems is configured to generate a set of simulation inputs for one of the plurality of defined time periods. At least one of the plurality of input generation subsystems is configured to generate a stochastic set of simulation inputs. The processor is further configured to generate the set of simulation inputs by implementing a input generation process defined by the selected one of the plurality of input generation subsystems and implement a statistical simulation of the target system based on the set of simulation inputs.

In various embodiments, a computer-implemented method is disclosed. The computer-implemented method includes steps of receiving a set of input generation parameters, determining a simulation time period for a simulation of the target system based on the set of input generation parameters, and selecting one of a plurality of input generation subsystems for the simulation time period. The simulation time period is one of a plurality of defined time periods and each of the plurality of input generation subsystems is configured to generate a set of simulation inputs for one of the plurality of defined time periods. At least one of the plurality of input generation subsystems is configured to generate a stochastic set of simulation inputs. The set of simulation inputs is generated by implementing a input generation process defined by the selected one of the plurality of input generation subsystems and a statistical simulation of a target system is implemented based on the set of simulation inputs.

In various embodiments, a non-transitory computer-readable medium having instructions stored thereon is disclosed. The instructions, when executed by a processor, cause a device to perform operations including receiving a set of input generation parameters, determining a simulation time period for a simulation of the target system based on the set of input generation parameters, and selecting one of a plurality of input generation subsystems for the simulation time period. The simulation time period is one of a plurality of defined time periods and each of the plurality of input generation subsystems is configured to generate a set of simulation inputs for one of the plurality of defined time periods. At least one of the plurality of input generation subsystems is configured to generate a stochastic set of simulation inputs. The plurality of input generation subsystems includes a historical sampling subsystem, a bootstrap sampling subsystem, a classification and regression tree subsystem, and a conditional tabular generative adversarial network. The instructions further cause the device to perform operations including generating the set of simulation inputs by implementing a input generation process defined by the selected one of the plurality of input generation subsystems and implementing a statistical simulation of a target system based on the set of simulation inputs.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments.

FIG. 2 illustrates a network environment configured to provide a simulation environment including hybrid input modeling, in accordance with some embodiments.

FIG. 3 illustrates an artificial neural network, in accordance with some embodiments.

FIG. 4 illustrates a tree-based artificial neural network, in accordance with some embodiments.

FIG. 5 illustrates a deep neural network, in accordance with some embodiments.

FIG. 6 is a flowchart illustrating a method of end-to-end simulation and optimization using hybrid input modeling, in accordance with some embodiments.

FIG. 7 is a process flow illustrating various steps of the method of end-to-end simulation and optimization using hybrid input modeling, in accordance with some embodiments.

FIG. 8 illustrates a hybrid input modeling engine including a plurality of input subsystems, in accordance with some embodiments.

FIG. 9 is a flowchart illustrating a method of generating simulation inputs using a bootstrap sampling model, in accordance with some embodiments.

FIG. 10 is a process flow illustrating various portions of the method of generating simulation inputs using a bootstrap sampling model, in accordance with some embodiments.

FIG. 11 illustrates a method of generating simulation inputs using a CART model, in accordance with some embodiments.

FIG. 12 illustrates a process flow including various steps of the method of generating simulation inputs using a CART model, in accordance with some embodiments.

FIG. 13 illustrates a method of generating simulation inputs using CTGAN modeling, in accordance with some embodiments.

FIG. 14 illustrates a process flow including various steps of the method of generating simulation inputs using CTGAN modeling, in accordance with some embodiments.

FIG. 15 illustrates a method of generating a trained machine learning model, in accordance with some embodiments.

FIG. 16 illustrates a process flow of the method of generating a trained machine learning model, in accordance with some embodiments.

FIG. 17 is a flowchart illustrating a method of generating a plurality of CART models, in accordance with some embodiments.

FIG. 18 illustrates a process flow of the method of generating a plurality of CART models, in accordance with some embodiments.

FIG. 19 is a flowchart illustrating a method of generating a plurality of CTGAN models, in accordance with some embodiments.

FIG. 20 is a process flow illustrating various steps of the method for generating a plurality of CTGAN models, in accordance with some embodiments.

FIG. 21 illustrates a data imputation volumetrics module, in accordance with some embodiments.

FIG. 22 illustrates a data imputation volumetrics module, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems end-to-end simulation using hybrid input modeling. In various embodiments a hybrid input modeling engine is configured to provide various types of stochastic inputs required for executing the end-to-end simulations. Generated inputs can include, but are not limited to, heuristic inputs, statistical inputs, and machine learning inputs such as deep learning model generated inputs. The hybrid input modeling engine enables the end-to-end simulation system to provide time-travel simulations, multi-granular simulations, multi-fidelity simulations, and combinations thereof.

In some embodiments, systems, and methods for end-to-end simulation includes one or more trained input generation models configured to generate stochastic inputs for use by a simulation system. The trained input generation models can include one or more models, such as a bootstrap sampling model, a classification and regression tree (CART) model, a conditional tabular generative adversarial network (CTGAN) model, and/or any other suitable input generation model. In some embodiments, various input generation models are configured to generate inputs for simulating systems at one or more predetermined time periods, such as simulations configured to simulate past operation, current operation, and/or future operation of a system.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree, a generative adversarial network, and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, neural networks which are trained (e.g., configured or adapted) to generate stochastic inputs for use in simulation, are disclosed. A neural network trained to generate statistical inputs may be referred to as a trained input generation model. A trained input generation model can be configured to receive a set of data defining one or more parameters of a simulation to be performed and generate a set of simulation input data that satisfies the provided parameters. For example, a trained input generation model can generate a set of simulation input data over a selected time period, having a set of selected simulation characteristics, having a selected granularity, etc.

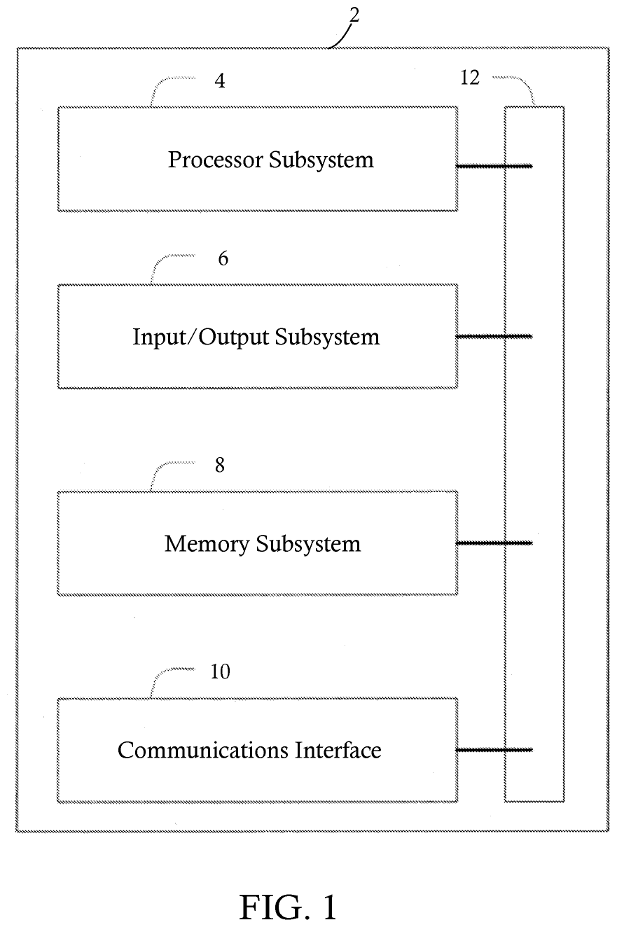

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for end-to-end simulation including hybrid input modeling, as described herein. The instruction set can be stored in any acceptable form of machine-readable instructions, including source code or various appropriate programming languages. Some examples of programming languages that can be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

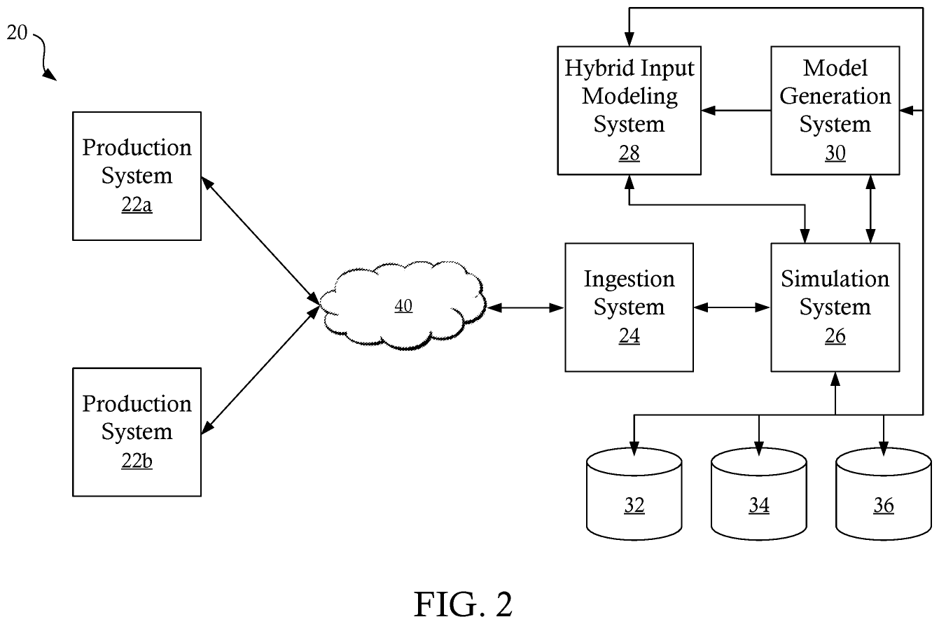

FIG. 2 illustrates a network environment 20 configured to provide end-to-end simulation including hybrid input modeling, in accordance with some embodiments. The network environment 20 includes a plurality of systems configured to communicate over one or more network channels, illustrated as network cloud 40. For example, in various embodiments, the network environment 20 can include, but is not limited to, one or more production systems 22a, 22b, at least one ingestion system 24, at least one simulation system 26, at least one hybrid input modeling system 28, at least one model generation system 30, at least one production data store 32, at least one model data store 34, and at least one input data store 36. It will be appreciated that any of the illustrated systems can include a system as described above in conjunction with FIG. 1. Although specific embodiments are discussed, herein it will be appreciated that additional systems, servers, storage mechanism, etc. can be included within the network environment 20.

Further, although embodiments are illustrated herein having individual, discrete systems, it will be appreciated that, in some embodiments, one or more systems can be combined into a single logical and/or physical system. For example, in various embodiments, one or more of the production systems 22a, 22b, ingestion system 24, simulation system 26, hybrid input modeling system 28, model generation system 30, production data store 32, model data store 34, and/or input data store 36 can be combined into a single logical and/or physical system. Similarly, although embodiments are illustrated having a single instance of each system, it will be appreciated that additional instances of a system can be implemented within the network environment 20. In some embodiments, two or more systems can be operated on shared hardware in which each system operates as a separate, discrete system utilizing the shared hardware, for example, according to one or more virtualization schemes.

In some embodiments, each of the production systems 22a, 22b are configured to generate sets of production data representative of system operations for a system or a portion of a system to be modeled. For example, in some embodiments, a system to be modeled includes a supply chain system, such as a retail supply chain system. Each of the production systems 22a, 22b is configured to generate a set of production data related to the supply chain system, such as, for example, data regarding orders, fulfillments, inventory, catalog items, etc. Although certain classes of data are discussed herein, it will be appreciated that the production systems 22a, 22b can generate production data representative of any portion of a system using any suitable format.

In some embodiments, production data generated by each of the production systems 22a, 22b is provided to and ingested by an ingestion system 24. The ingestion system 24 can include any suitable elements configured to receive and ingest the production data, such as, for example, one or more pipeline modules or engines configured to receive discrete and/or continuous data streams from the production systems 22a, 22b. The ingestion system 24 can be configured to perform real-time, semi-real-time (e.g., micro batching), and/or batch ingestion of the received production data.

In some embodiments, the ingestion system 24 is configured to receive the production data, process the received production data, and store the production data in one or more storage systems, such as the production data store 32. The ingestion system 24 can be configured to implement any suitable ingestion modules, processes, algorithms, etc., such as, for example, extraction processes, processing modules, type identification processes, flow tracking and visualization processes, volume processes, security processes, sanitization processes, normalization processes, etc. Although specific embodiments are discussed herein, it will be appreciated that any suitable set of ingestion processes can be utilized to process received production data.

In some embodiments, the simulation system 26 is configured to generate one or more simulations of a predetermined system (e.g., a target system). The predetermined system can include any suitable system, such as a real-world system, a digital system, a mixed real-world and digital system, a conceptual system, etc. The simulated system can include multiple subsystems, sub-components, sub-assemblies, etc. that can each be simulated separately and/or as a single system. The simulation system 26 can utilize any suitable simulation techniques, processes, etc., to simulate one or more systems. In some embodiments, the simulation system 26 is configured to utilize a stochastic simulation process configured to receive one or more stochastic inputs.

In some embodiments, the simulation system 26 is configured to perform stochastic simulation of a supply chain system for a retailer. The supply chain system can include brick-and-mortar supply chain processes (e.g., in-store stocking, sales, tracking, warehousing, etc.) and/or online supply chain processes (e.g., distributed stock tracking, internet-based sales or interactions, delivery processes, third-party merchant processes, etc.). The simulation system 26 can be configured to receive a plurality of stochastic inputs, for example, from a hybrid input modeling system 28, and/or a plurality of historical inputs, for example, from the production data store 32. The simulation system 26 is configured to receive any suitable type of input, such as, for example, a heuristic input, a statistical input, a deep learning generated input, etc.

In some embodiments, the simulation system 26 can be configured to provide variable time simulations, multi-fidelity simulations, and/or multi-granularity simulations based on the types of inputs and the periods to be simulated. A simulation system 26 configured to provide variable time simulation allows the same or similar simulations to be executed over a wide spectrum of continuous and/or discrete time periods encompassing prior activity of the system (e.g., a past time period), current activity of the system (e.g., a present time period), or predicted activity of the system (e.g., a future time period).

In some embodiments, variations in the time period being modeled result in granularity changes in the simulation. For example, in some embodiments, the granularity of a simulation is a function of time such that simulations performed for a past time period can be/are performed at a highest level of granularity (e.g., having a fine granularity), with the granularity decreasing (e.g., a fine to medium granularity) as the time period moves to the present and decreasing further (e.g., having a coarse granularity) when the time period is in the future. In some embodiments, granularity can be adjusted independent of the time period variation.

In some embodiments, the simulation system 26 is configured to provide multi-granularity simulations. For example, in some embodiments, the fidelity of a simulation is a function of time, granularity, and type, such that simulations performed for a past time period, a current time period, or a near-future time period have a high fidelity while simulations performed for farther-future time periods have decreasing, or lower, fidelity. In order to facilitate variable time, granularity, and/or fidelity simulations, the simulation system 26 is configured to receive sets of differentiated input data for past, present, and/or future time periods for multiple levels of granularity and/or fidelity requirements. The hybrid input modeling system 28 is configured to generate suitable inputs for the simulation system 26.

In some embodiments, the hybrid input modeling system 28 is configured to generate one or more sets of heuristic inputs for the simulation system 26 based on one or more parameters of a simulation to be performed. For example, the hybrid input modeling system 28 can be configured to implement one or more trained models or statistical processes to generate heuristic, statistical, deep learning based, machine learning based, and/or other types of stochastic inputs for the simulation system 26. The hybrid input modeling system 28 can implement multiple, different input generation processes simultaneously, sequentially, and/or intermittently to generate required inputs for a simulation. In some embodiments, the hybrid input modeling system 28 is configured to select an input generation process based on one or more of a time period variable, a granularity requirement, and/or a fidelity requirement for the simulation.

As one example, in some embodiments, the hybrid input modeling system 28 is configured to generate a demand parameter for use in a simulation. The accuracy of a supply chain simulation is directly tied to the accuracy of the demand parameter, and the accuracy of the simulation directly impacts the usefulness and applicability of those simulations. Thus, a realistic (e.g., accurate) demand parameter for any given gross merchandise value (GMV) or aggregate units is required and should be dynamically adjustable and/or callable during operation of the simulation. In addition, the simulation is impacted by sampling of the demand parameter at large scale efficiently during run time of the simulation. The disclosed hybrid input modeling system 29 provides parameters, such as the demand parameter, to allow for varying time horizons, granularity, and fidelity during simulations of a supply chain system.

In some embodiments, the hybrid input modeling system 28 is configured to generate past time horizon, fine granularity, and/or high fidelity input data (referred to herein as “FGHF input data”). FGHF input data can be a replica, or substantial copy, of production data with one or more feature transformations applied to adapt the production data to the simulation system interfaces. The hybrid input modeling system 28 can be configured to apply feature transformations in real-time, e.g., generating on-demand FGHF input data for a simulation, and/or pre-generate batches of transformed FGHF input data usable for one or more simulations based on the applied feature transformations. In some embodiments, the feature transformations include generation of one or more velocity codes (e.g., superhead, head, torso, tail, etc.) and an item type (e.g., sort, non-sort, fresh, etc.). The velocity codes and item types provided herein are provided as examples and it will be appreciated that any suitable velocity codes and/or item type label can be applied for a specific target system. The feature transformations can be obtained/generated from one or more production sources and/or can be imputed from one or more other features, such as imputed dimensions from a SKU volumetrics model. It will be appreciated that the feature transformations can be selected to provide necessary inputs for simulation of the target system.

In some embodiments, the hybrid input modeling system 28 is configured to generate current and/or near-term time horizon, medium to fine granularity, and/or medium to high fidelity input data (referred to herein a “MGMF input data”). MGMF input data can be generated using one or more techniques and/or trained models, such as, for example, one or more stratified bootstrap models, one or more CART based models, one or more heuristics models, a combination thereof, and/or any other suitable models.

In various embodiments, a stratified bootstrap model can be configured to generate MGMF input data based on sampling from historical data over a predetermined rolling window. A set of GMV, aggregate units, and time period parameters drive the specific parameters of the stratified bootstrap model, for example, determining sampling (e.g., sample rate) for a selected time window from historical data to generate individual demand data having fine granularity and high fidelity. Additionally, in various embodiments, a CART model can be configured to generate volumetrics for a subset of catalog elements, such as a subset of SKUs, which can be used in demand generation and a heuristic model can be configured based on demand distribution, regions, category mixes, and/or other parameters of a simulation model.

In some embodiments, the hybrid input modeling system 28 is configured to generate future time horizon, coarse granularity, and/or low fidelity input data (referred to herein as “CGLF input data”). Due to increased uncertainty in predicting future system operations, inputs can be modeled as complex stochastic processes. For example, a simulation can utilize a set of joint variables, both discrete and/or continuous. In some embodiments, the variables are correlated, such as temporal, spatial, and/or auto-correlations. In some embodiments, the variables include multimodal variables and can represent a non-stationary stochastic feature. In order to provide multi-dimensional variables that operate for large scale systems meeting each of these requirements, the hybrid input modeling system 28 can be configured to implement one or more trained neural networks.

For example, in some embodiments, the hybrid input modeling system 28 is configured to implement one or more deep generative adversarial networks (GANs). A trained GAN can be configured to model complex joint distribution of multivariate data of both continuous and discrete forms in order to generate correlated, multimodal, and/or multivariate stochastic inputs for use in system modeling. A trained GAN learns a joint distribution implicitly and provides sampled values closely representative of real-world patterns sampled from training data. In some embodiments, a trained GAN is scalable over multiple orders of magnitude to provide larger and/or smaller variable sets based on simulation requirements.

The hybrid input modeling system 28 is configured, for example through the use of one or more GAN models, to generate CGLF data that leverages large scale data generated by production systems to fit a model to learn the joint distributions of a variable, such as a demand variable. Sampling from the learnt implicit distribution can be used to generate samples up to any order of magnitude. A trained GAN, as disclosed herein, provides a high degree of accuracy and removes limitations found in prior statistical approaches, allowing sampling of demand at any scale efficiently and learning of non-stationary changes without requiring manual intervention or retraining on new data.

In some embodiments, the model generation system 30 is configured to generate (e.g., train) one or more input generation models for implementation by the hybrid input modeling system 28. For example, in various embodiments, the model generation system 30 can be configured to generate one or more of a bootstrap sampling model, a CART model, a GAN model, a CTGAN model, and/or any other suitable machine learning model. The model generation system 30 can be configured to implement a supervised learning process, an unsupervised learning process, and/or a semi-supervised learning process. For example, a supervised model training engine can be configured to apply a supervised training process to an untrained model based on a set of labeled training data. The labeled training data can include data representative of a stochastic input series, such as actual production data and/or previously generated and verified stochastic input series. As another example, an unsupervised learning engine can be configured to apply an unsupervised training process to an untrained model based on unlabeled data by generating groupings, e.g., clusters, of data based on the unsupervised data sets.

In some embodiments, the model generation system 30 is configured to generate a plurality of individual input generation models. For example, the model generation system 30 can be configured to generate individual input generation models having various frameworks, inputs, and/or model parameters. The model generation system 30 can be configured to generate any suitable input generation models applicable at one or more time frames, such as past time frames, present or near-future time frames, and/or long-term future time frames and/or applying any suitable level of granularity and/or fidelity. Each of the individual input generation models can be generated using training data including actual production data and/or previously generated input data sets.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

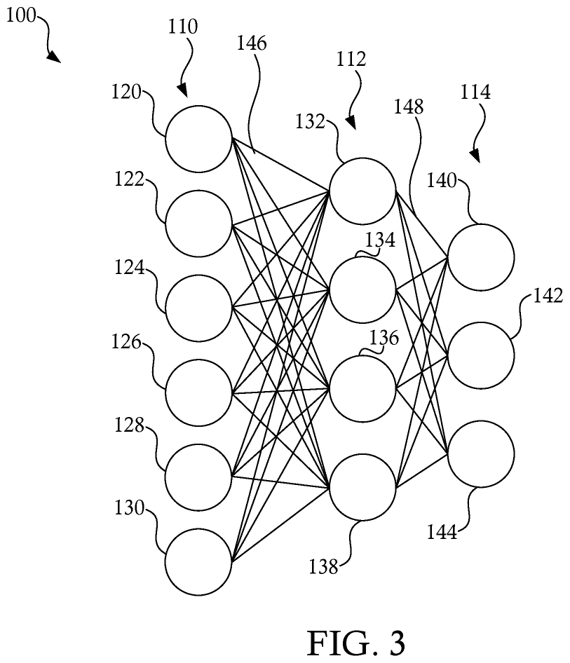

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the, interval [−1, 1], within the interval [0, 1], and/or within any other suitable interval. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

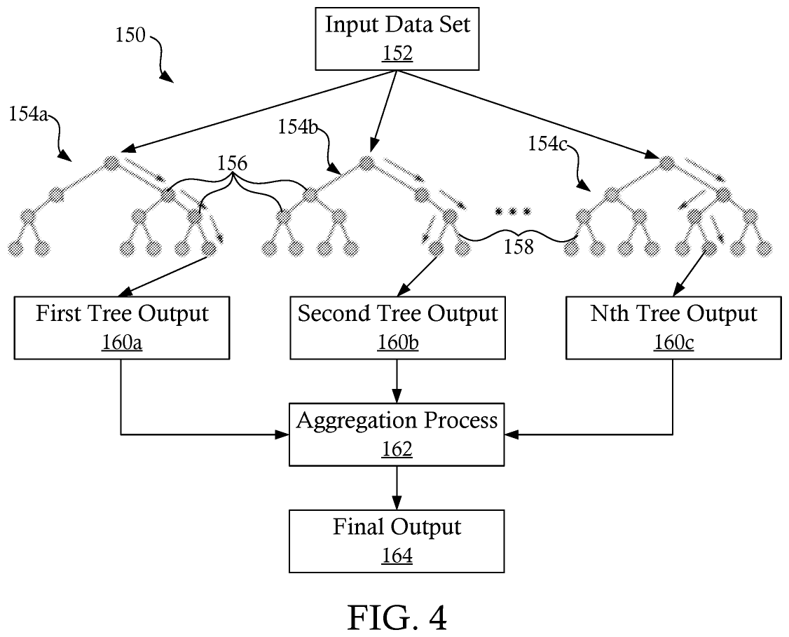

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

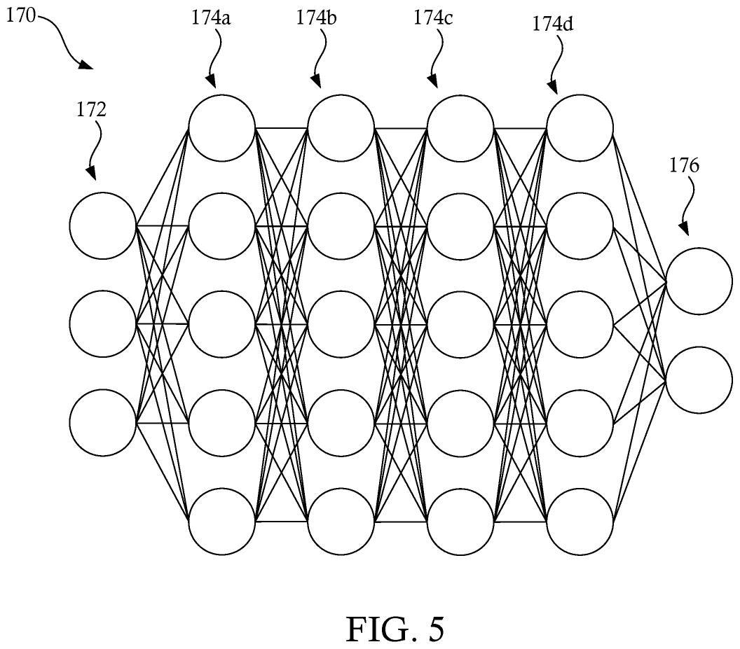

FIG. 5 illustrates a deep neural network (DNN) 170, in accordance with some embodiments. The DNN 170 is an artificial neural network, such as the neural network 100 illustrated in conjunction with FIG. 3, that includes representation learning. The DNN 170 can include an unbounded number of (e.g., two or more) intermediate layers 174a-174d each of a bounded size (e.g., having a predetermined number of nodes), providing for practical application and optimized implementation of a universal classifier. Each of the layers 174a-174d can be heterogenous. The DNN 170 can is configured to model complex, non-linear relationships. Intermediate layers, such as intermediate layer 174c, can provide compositions of features from lower layers, such as layers 174a, 174b, providing for modeling of complex data.

In some embodiments, the DNN 170 can be considered a stacked neural network including multiple layers each configured to execute one or more computations. The computation for a network with L hidden layers can be denoted as:

$$f ( x ) = f [ {a}^{( L + 1 )} ( {h}^{( L )} ( {a}^{( L )} ( … ( {h}^{( 2 )} ( {a}^{( 2 )} ( {h}^{( 1 )} ( {a}^{( 1 )} ( x ) ) ) ) ) ) ) ) ]$$

where a^{(l)}(x) is a preactivation function and h^{(l)}(x) is a hidden-layer activation function providing the output of each hidden layer. The preactivation function a^{(l)}(x) can include a linear operation with matrix W^{(l)} and bias b^{(l)}, where:

$${a}^{( l )} ( x ) = {W}^{( l )} x + {b}^{( l )}$$

In some embodiments, the DNN 170 is a feedforward network in which data flows from an input layer 172 to an output layer 176 without looping back through any layers. In some embodiments, the DNN 170 can include a backpropagation network in which the output of at least one hidden layer is provided, e.g., propagated, to a prior hidden layer. The DNN 170 can include any suitable neural network, such as a self-organizing neural network, a recurrent neural network, a convolutional neural network, a modular neural network, and/or any other suitable neural network.

In some embodiments, a DNN 170 can include a neural additive model (NAM). An NAM includes a linear combination of networks, each of which attends to (e.g., provides a calculation regarding) a single input feature. For example, an NAM can be represented as:

$$y = β + {f}_{1} ( {x}_{1} ) + {f}_{2} ( {x}_{2} ) + … + {f}_{K} ( {x}_{K} )$$

where β is an offset and each fᵢ is parametrized by a neural network. In some embodiments, the DNN 170 can include a neural multiplicative model (NMM), including a multiplicative form for the NAM mode using a log transformation of the dependent variable y and the independent variable x:

$$y = {e}^{β} {e}^{f ( log x )} {e}^{{\sum }_{i} {f}_{i}^{d} ( {d}_{i} )}$$

where d represents one or more features of the independent variable x.

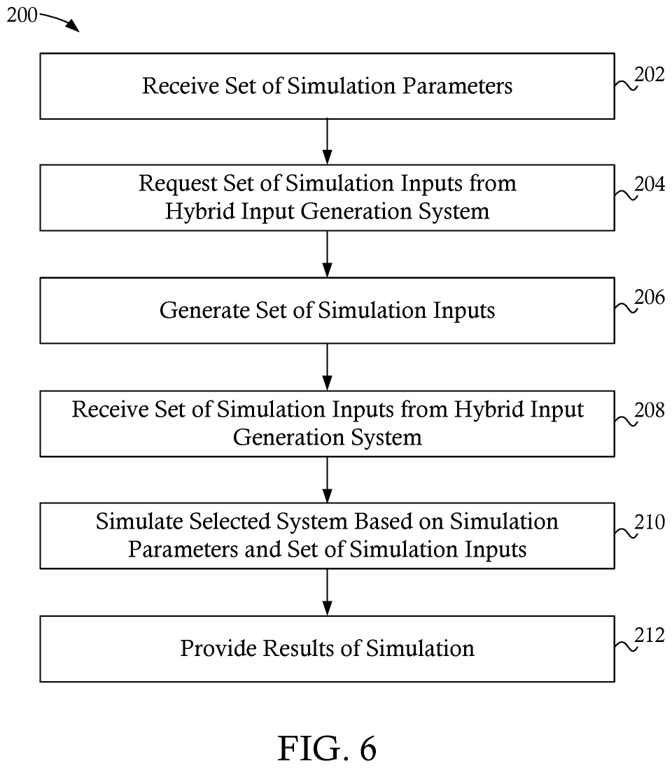

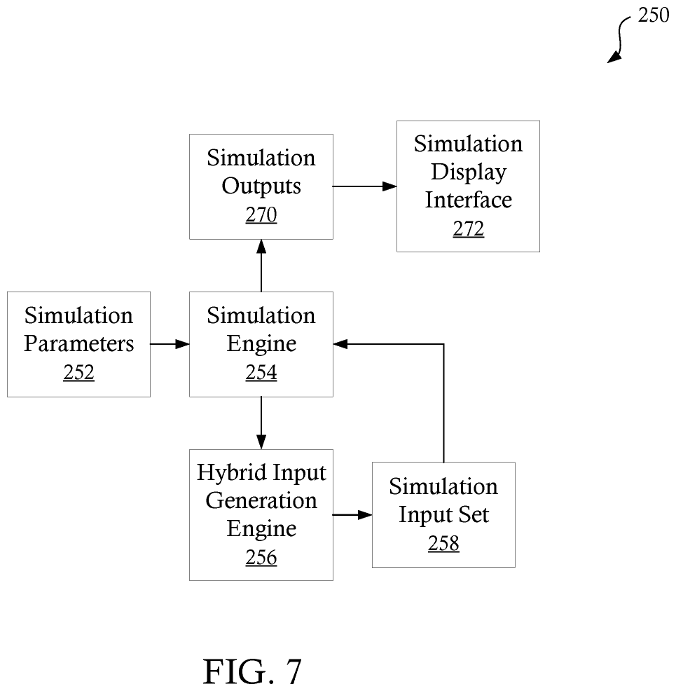

FIG. 6 is a flowchart illustrating a method 200 of end-to-end simulation and optimization using hybrid input modeling, in accordance with some embodiments. FIG. 7 is a process flow 250 illustrating various steps of the method 200 of end-to-end simulation and optimization using hybrid input modeling, in accordance with some embodiments. At step 202, a set of simulation parameters 252 is received by a simulation engine 254. The simulation engine 254 is configured to perform statistical modeling of one or more systems, such as, for example, a supply chain system. The simulation parameters 252 include one or more parameters defining a scope of a simulation. For example, in various embodiments, the simulation parameters 252 can include a time frame parameter (e.g., past-simulation, present or near-term simulation, future simulation, etc.), a granularity parameter (e.g., coarse granularity, medium granularity, fine granularity, etc.), a fidelity parameter (e.g., low fidelity, medium fidelity, high fidelity, etc.), demand generation parameters (e.g., parameters related to the demand to be simulated), network inputs (e.g., parameters defining certain structural elements of the simulated process or network), constraint parameters (e.g., parameters constraining the simulation or the system during simulation), etc. Although specific embodiments are discussed herein, it will be appreciated that any suitable input parameters, such as required or optional parameters, for the simulation can be included in the simulation parameters 252.

At step 204, the simulation engine 254 requests at least one set of simulation inputs 258 from a hybrid input generation engine 256. The set of simulation inputs 258 can include any suitable input required to implement a simulation. For example, in some embodiments, set of simulation inputs 258 can include, but is not limited to, historical data such as prior production data representative of actual performance or operation of a modeled system during a prior time period, real-time data representative of current conditions, inputs, and/or operation of a modeled system, and/or predicted inputs generated for one or more time periods, such as past, present, and/or future predicted inputs. As discussed in greater detail below, the hybrid input generation engine 256 is configured to provide any requested type of simulation input 258.

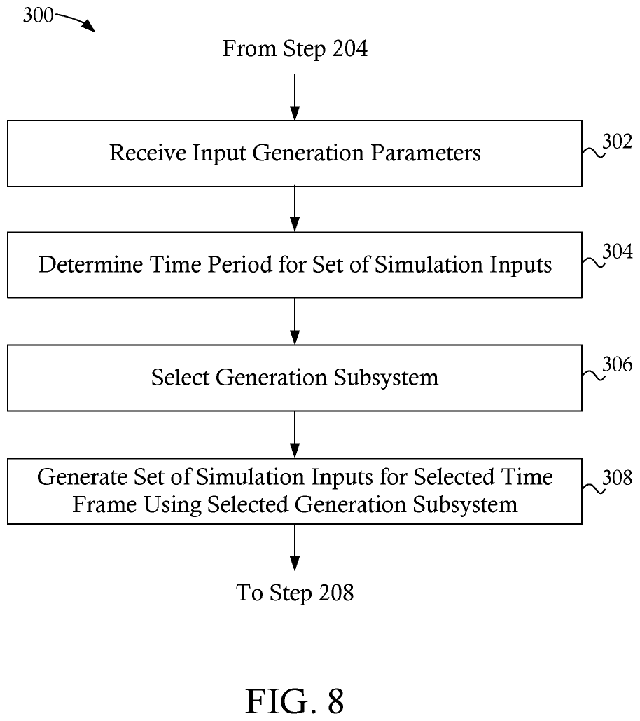

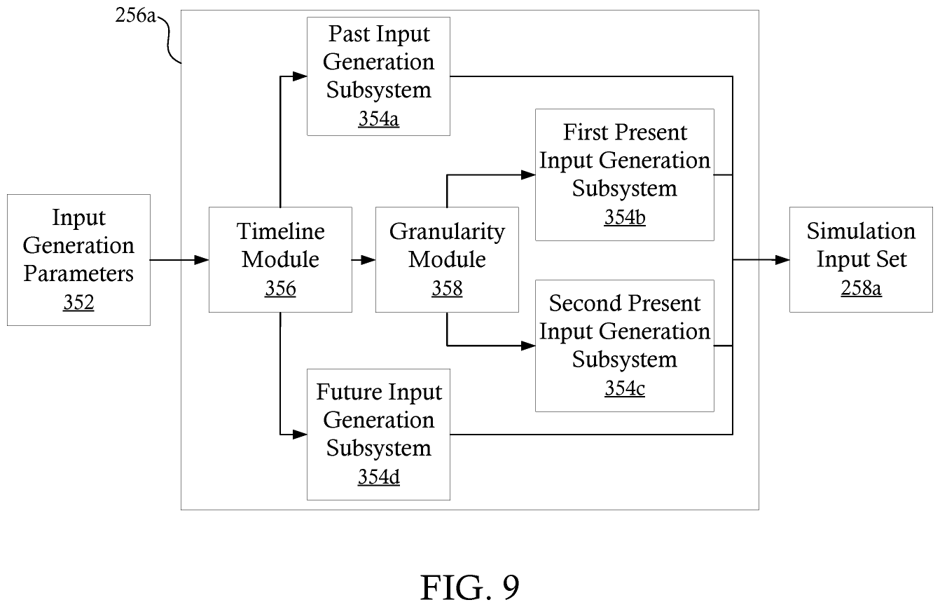

At step 206, the hybrid input generation engine 256 executes a method of generating a set of simulation inputs 258. FIG. 8 is a flowchart illustrating a method 300 of generating a set of simulation inputs 258, in accordance with some embodiments. FIG. 9 illustrates one embodiment of a hybrid input generation engine 256a including a plurality of input generation subsystems 354a-354d, in accordance with some embodiments. At step 302, a hybrid input generation engine 256a receives a one or more input generation parameters 352. The input generation parameters 352 include one or more parameters for use in generating a set of simulation inputs 258a. The inputs generation parameters 352 can define any suitable parameters, such as, for example, demand generation inputs, simulation scenario inputs, etc. In some embodiments, the input generation parameters 352 include a subset of the simulation parameters 252 received by a simulation engine 254, as discussed above.

At step 304, the hybrid input generation engine 256a determines a time period for the requested set of simulation inputs 258a. For example, in some embodiments, the hybrid input generation engine 256a includes a timeline module 356 configured to identify a time period for the generated simulation data based on one or more input generation parameters 352. In some embodiments, an input generation parameter 352 identifies a selected time period by providing a time range, e.g., a date range, and the timeline module 356 is configured to determine the relative position of the specified time period with respect to the current time, e.g., in the past, present/near-future, or far future. In some embodiments, the input generation parameters 352 identify one of a past time period, a present time period, a near-future time period, or a far future time period. The differentiation between time periods (e.g., past, present, future, etc.) can be predetermined and/or can be based on one or more received parameters.

At step 306, a generation subsystem 354a-354d corresponding to the identified time period is selected and a subset of the input generation parameters 352 are provided to the selected generation subsystem 354a-354d. In some embodiments, the hybrid input generation engine 256a includes a past input generation subsystem 354a, a first present/near-term input generation subsystem 354b, a second present/near-term input generation subsystem 354c, and a future input generation subsystem 354d. Although embodiments are discussed herein having specific input generation subsystems 354a-354d, it will be appreciated that additional input generation subsystems can be added, illustrated input generation subsystems can be omitted, and/or illustrated subsystems can be combined. Each of the input generation subsystems 354a-354d is configured to generate one or more sets of input data for use by the simulation engine 254.

In some embodiments, a past input generation subsystem 354a is configured to generate a set of simulation inputs 258a for a prior time period. The past input generation subsystem 354a can be configured to obtain production data from one or more sources, such as a production data store 32. The production data represents prior operation of a modeled system and/or subsystem. The past input generation subsystem 354a can be configured to provide the production data directly as a set of simulation inputs 258a and/or can be configured to apply one or more transformations to the production data.

In some embodiments, the past input generation subsystem 354a is configured to apply one or more transformations to the production data to convert prior production data from a first set of parameters that existed when the production data was collected to a second set of parameters applicable to a simulation executed by the simulation engine 254. For example, in various embodiments, the production data can be scaled up or down based on one or more scaling factors, can be shifted to account for different factors in the simulation as compared to the production data, and/or otherwise can be transformed to generate a set of simulation data for performing a past simulation. The set of simulation inputs 258a generated by the past input generation subsystem 354a have high fidelity and fine granularity, enabling highly accurate past simulations.

Present/near-term input generation subsystems 354b, 354c are configured to provide a set of simulation inputs 258a for a current or near-future time period. In some embodiments, multiple present/near-term input generation subsystems 354b, 354c are provided at different levels of granularity and/or fidelity. For example, in the illustrated embodiment, the hybrid input generation engine 256a includes a first present/near-term input generation subsystem 354b configured to provide a set of simulation inputs 258a having a high granularity and a high fidelity. A second present/near-term input generation subsystem 354c is configured to provide simulation inputs 258b having a medium granularity and a medium fidelity. In some embodiments, a granularity selection model 358 is configured to receive one or more input generation parameters 352 and select one or more of the first present/near-term input generation subsystem 354b or the second present/near-term input generation subsystem 354c.

In some embodiments, a first present/near-term input generation subsystem 354b is configured to provide a set of simulation inputs 258a at a first granularity and/or a first fidelity. For example, in the illustrated embodiment, the first present/near-term input generation subsystem 354b is configured to provide a set of simulation inputs 258a having fine granularity and high fidelity. The first present/near-term input generation subsystem 354b can utilize any suitable model to generate present or near-term simulation data, such as, for example, a bootstrap sampling model.

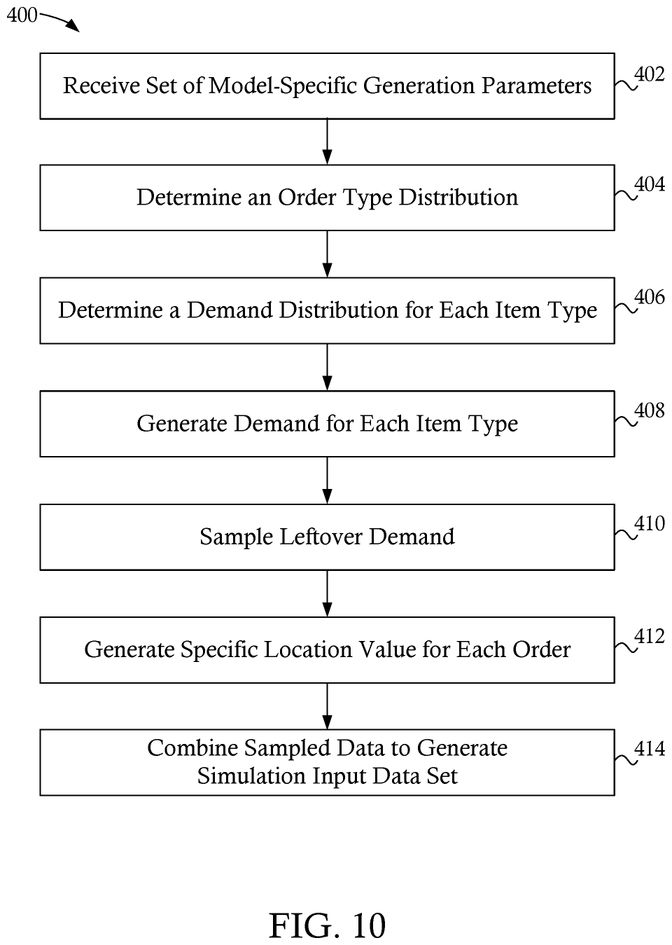

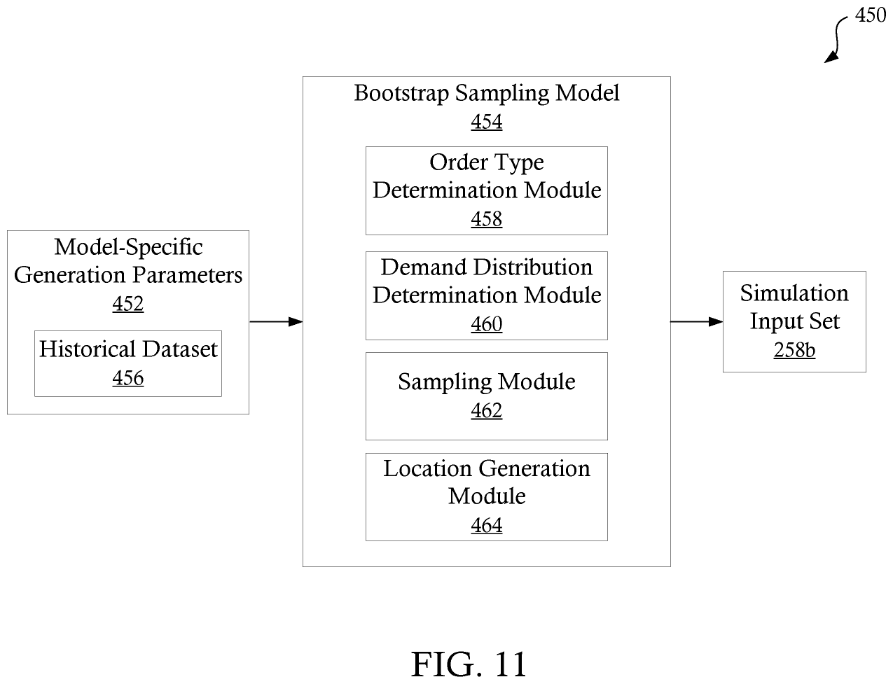

FIG. 10 is a flowchart illustrating a method 400 of generating simulation inputs using a bootstrap sampling model, in accordance with some embodiments. FIG. 11 is a process flow 450 illustrating various portions of the method 400 of generating simulation inputs using a bootstrap sampling model 454, in accordance with some embodiments. At step 402, a bootstrap sampling model 454 receives a set of model-specific generation parameters 452. The set of model-specific generation parameters 452 can include, but is not limited to, a date for which a demand generation is to be run, a number of demand units to be generated for each item type in a catalog, one or more values to allow the number of demand units to be generated (e.g., a total gross merchandising value (GMV) of the demand, a share percentage of each item type in the total GMV, an average unit retail price (AUR) of each item type, etc.), one or more assortment channel identifiers, etc. In some embodiments, the date for which demand generation is to be run can include multiple dates such that the bootstrap sampling model 454 generates simulation inputs over multiple days and/or multiple assortment channels.

In some embodiments, the set of model-specific generation parameters 452 includes a historical dataset 456 that is to be sampled. For example, in some embodiments, the set of model-specific generation parameters 452 includes a historical dataset 456 collected from and associated with the system to be modeled by a simulation process and/or a subsystem of the system to be modeled. The historical dataset 456 can include data collected during prior and/or concurrent operation of the system to be simulated.

At step 404, the bootstrap sampling model 454 determines an order type distribution from historical dataset 456. For example, in some embodiments, an order type determination module 458 can define an order type based on distinct item types contained within an order (e.g., merchandise, grocery, etc.). In such embodiments, if there are two item types within the historical data, e.g., item type A and item type B, an order type that can potentially include only items of type A can be defined as an A order type, an order type that can potentially include only items of type B can be defined as a B order type, and an order that can potentially include items of type A and items of type B can be defined as an A-B order type. In one example embodiment, a bootstrap sampling model 454 configured to generate demand for a single channel can include a maximum of 3 distinct items in any order and have a maximum of seven order types. Although specific embodiments are discussed herein, it will be appreciated that any suitable number of channels can be utilized defining any number of distinct items and having any suitable number of order types based on the number of distinct items within each order.

At optional step 406, in some embodiments, the bootstrap sampling model 454 determines one or more metrics and/or distributions from the historical dataset 456. For example, in some embodiments, for each item type that can potentially be included in an order type, a demand distribution determination module 460 can calculate a demand distribution for each order type. In some embodiments, a first item type demand distribution can include a distribution of 80% for orders containing only the first item type, 10% for orders containing the first item type and a second item type, 10% for orders containing the first item type and a third item type, and 0% for orders that do not contain the first item type. Although specific embodiments are discussed herein, it will be appreciated that any suitable demand distribution can be determined from the historical dataset 456. The metrics and/or distributions can be generated by the bootstrap sampling model 454 and/or by a metric/distribution generation module (not shown).

In some embodiments, an average unit per order can be determined for each order type. For example, a first order type including a first item type and a second item type can have an average of 7 units per order with the average units being split at an average of 5 units of the first item type and 2 units of the second order type. Although specific embodiments are discussed herein, it will be appreciated that an order type can have any suitable number of average units having any distribution over the item types included in the order type.

In some embodiments, metrics and/or distributions can be generated over multiple assortment channels and/or multiple days. For example, with respect to assortment channels, the number of item types that can be included in an order can be three times the number of assortment channels (n) and the maximum number of order types possible is 2ⁿ−1. Metrics and distributions can be determined as previously discussed based on the number of item types and maximum number of order types in the multiple assortment channels. Similar calculations can be performed to generate metrics and/or distributions over multiple days.

At step 408, the bootstrap sampling model 454 generates a demand for each item type by bootstrap sampling of each of the order types based on the item type distribution previously determined. For example, a sampling module 462 can determine that demand units related to an item type are distributed among only order types including that item type, e.g., demand units of a first item type will be distributed among only those order types including the first item type. Based on this known distribution, the number of units to be distributed in each one of the potential order types can be determined (e.g., calculated) and the sampling module 462 can determine the number of orders to be sampled from each order type to meet the demand that is to be generated for an item type. In some embodiments, the sampling module 462 determines the number of orders to be sampled from each order type by dividing the number of units for an order type by the average units per order for the item type and order type combination.

The number of orders to be sampled for each order type can be different when calculated with respect to each item type based on the demand requirements. In some embodiments, conflicts between the number of orders to be sampled can be resolved by taking the minimum number of order to be sampled for each item type. For example, if a demand requirement as calculated with respect to a first item type for a first order type requires X samples of a first item type and a demand requirement as calculated with respect to a second item type for a first order type results in Y samples of a first item type being required, the bootstrap sampling model can be configured to select Y samples of the first item type.

In some embodiments, the bootstrap sampling model 454 is configured to perform stratified sampling. For example, data can be stratified within each order type based on a time parameter (e.g., the time at which the order was placed, time at which the order was fulfilled, etc.), a location parameter (e.g., order zip code, delivery zip code, etc.), and/or any other suitable parameter. In some embodiments, the historical data can be stratified based on two or more parameters to generate a multi-parameter stratification for sampling.

At step 410, the bootstrap sampling model 454 samples leftover demand. In some embodiments, the sampling module 462 samples leftover demand by identifying remaining units of each item type within each order type and sampling from the remaining units for only the identified item type. For example, in some embodiments, each order type can be sequentially examined to identify leftover demand and sampling can be performed solely on the leftover demand within a specific order type.

At step 412, a specific location value is generated for each order in the historical dataset 456. For example, in some embodiments, one or more specific location values, such as a latitude and longitude value, is generated and assigned to each order by a location generation module 464. The latitude and longitude, and/or other specific location values, can be selected or generated based on higher level location data included in each order within the historical dataset. For example, each order within a historical dataset 456 can include a zip code identifying a delivery location for the order.

A zip code can correspond to a large geographic area. In order to provide for simulation of various downstream processes, such as last mile delivery, transportation costs, etc., a specific location within the identified zip code can be assigned for each order. In some embodiments, the specific location includes a latitude and longitude value corresponding to a house or other deliverable location within the zip code. The latitude and longitude values can be randomly assigned (from a limited range corresponding to locations within the zip code) and/or assigned based on one or more parameters, algorithms, etc. In some embodiments, uniform random sampling is performed to identify a valid latitude and longitude corresponding to a zip code associated with an order in the historical dataset 456.

At step 414, the data sampled from the individual order types and the data sampled from the leftover demand are combined and output to provide a set of simulation inputs 258b closely corresponding to the historical dataset 456. The set of simulation inputs 258b generated by the bootstrap sampling model 454 has high fidelity as compared to the historical data collected from the system to be simulated, and can be utilized in a simulation providing fine granularity.

With reference again to FIGS. 8 and 9, in some embodiments, a second present/near-term input generation subsystem 354c is configured to provide a set of simulation inputs 258a at a second granularity and/or a second fidelity. For example, in the illustrated embodiment, the second present/near-term input generation subsystem 354c is configured to provide a set of simulation inputs 258a having medium granularity and medium fidelity. The second present/near-term input generation subsystem 354c can utilize any suitable model to generate present or near-term simulation data, such as, for example, a CART based input generation model or a heuristics based input generation model.

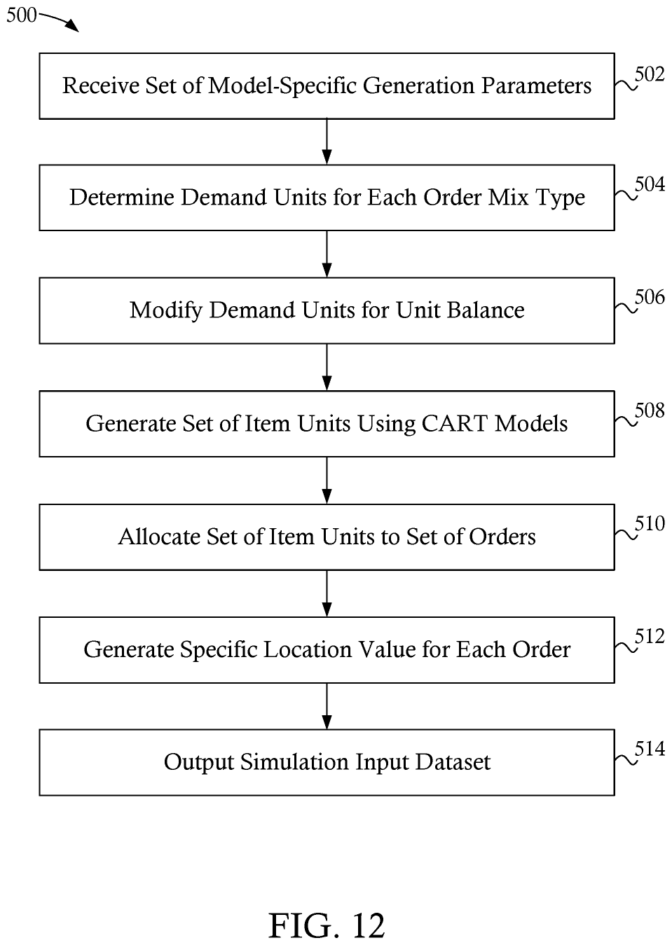

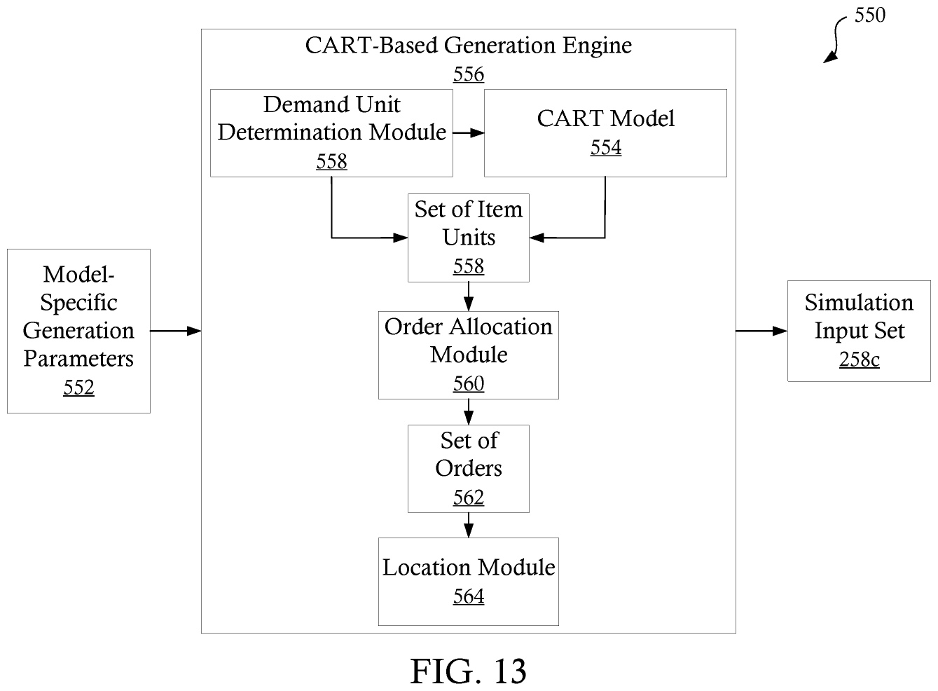

FIG. 12 illustrates a method 500 of generating a set of simulation inputs using one or more CART models, in accordance with some embodiments. FIG. 13 illustrates a process flow 550 including various steps of the method 500 of generating a set of simulation inputs using one or more CART models 554a-554e, in accordance with some embodiments. At step 502, a set of model-specific generation parameters 552 is received. The set of model-specific generation parameters 552 can include one or more parameters definitions for configuring one or more CART models 554 to generate a set of simulation inputs 258c. The set of model-specific generation parameters 552 can include, but is not limited to, a time parameter (e.g., a parameter defining a date for generation of simulation inputs), a number of units to include in the output, a velocity distribution, an order mix distribution, and/or any other suitable parameters. In some embodiments, a CART-based generation engine 556 can be configured to provide one or more default parameters if specific values are not provided in the set of model-specific generation parameters 552.

At step 504, a number of demand units to be calculated for each order mix type is generated. In some embodiments, a demand unit determination module 558 determines a number of demand units for each order type based on one or more inputs in the set of model-specific generation parameters 552, such as, for example, the number of units in the output and an order mix distribution. As discussed above, an order mix type, or order type, can be defined based on distinct item types contained within an order (e.g., merchandise, grocery, etc.). For example, if there are two item types within the historical data, e.g., item type A and item type B, an order type that can potentially include only items of type A can be defined as an A order type, an order type that can potentially include only items of type B can be defined as a B order type, and an order that can potentially include items of type A and items of type B can be defined as an A-B order type.

At optional step 506, the number of demand units for one or more order types are modified to maintain a unit balance. For example, in some embodiments, the demand unit determination module 558 reduces the demand units for at least a first order type when the number of orders for an order type determined by the provided unit per order (UPO) is greater than the number of units to be allocated in an order mix file. The number of orders for the first order type can be adjusted to match the order mix file and the UPO can be regenerated based on the modified number of orders, which maintains the selected order type distribution and integer output.

At step 508, a set of item units 560 including associated attributes is generated by one or more CART models 554. In some embodiments, a CART model 554 is obtained for each combination of a set of parameters included within the model-specific generation parameters 552. For example, in some embodiments, a CART model 554 can be obtained for each item category and/or velocity distribution included in and/or defined by the model-specific generation parameters 552. In some embodiments, a CART model 554 is obtained for each item type that can potentially be included in any of the order types determined at step 504 for a selected demand velocity as defined by the model-specific generation parameters 552. In some embodiments, the model-specific generation parameters 552 can include variable demand velocity across multiple item types and a CART model 554 can be configured to reflect each combination of item type and demand velocity defined by the set of model-specific generation parameters 552.

At step 510, an allocation module 562 allocates the set of item units 560 to a set of orders 564 as determined by the order type mix. In some embodiments, the set of item units 560 are assigned to each order using a least remainder approach, although it will be appreciated that any suitable allocation process can be applied. A least remainder approach assures that an integer number of units are assigned to each order. Although embodiments are discussed herein including a least remainder approach, it will be appreciated that any allocation process, including integer and/or partial allocation processes, can be used to allocate item units to one or more orders.

At step 512, delivery locations are generated and/or assigned to each order in the set of orders 564 a location generation module 566 based on a distribution defined for the simulation. For example, in some embodiments, and as discussed above with respect to the bootstrap sampling model 454, one or more specific location values, such as a latitude and longitude value, is generated and assigned to each order. The latitude and longitude, and/or other specific location values, can be selected or generated based on higher level location data, for example, as defined in the model-specific generation parameters 552. For example, in some embodiments, a zip code distribution can be defined as a model-specific generation parameter 552 and the set of orders 564 can be allocated to addresses within each selected zip code according to the zip code distribution.

At step 514, a set of simulation inputs 258c is output. The set of simulation inputs 258 includes the set of orders 564 having allocated delivery locations. In some embodiments, the set of simulation inputs 258c can include a subset of the set of orders 564. The set of simulation inputs 258c generated by the CART-based generation engine 556 has medium fidelity as compared to the historical data collected from the system to be simulated, and can be utilized in a simulation providing medium granularity.

With reference again to FIGS. 8 and 9, a future input generation subsystem 354d is configured to provide a set of simulation inputs 258a for a future time period. The future input generation subsystem 354d can include any suitable model configured to generate a set of simulation inputs 258a for simulating a system at a future time period. In some embodiments, the future input generation subsystem 354d includes one or more trained models, such as one or more CTGAN models, configured to provide coarse granularity and low fidelity data that is capable of providing accurate simulation of a selected system or subsystem. In some embodiments, the set of simulation inputs 258a generated by the future input generation subsystem 354d includes stochastic inputs.

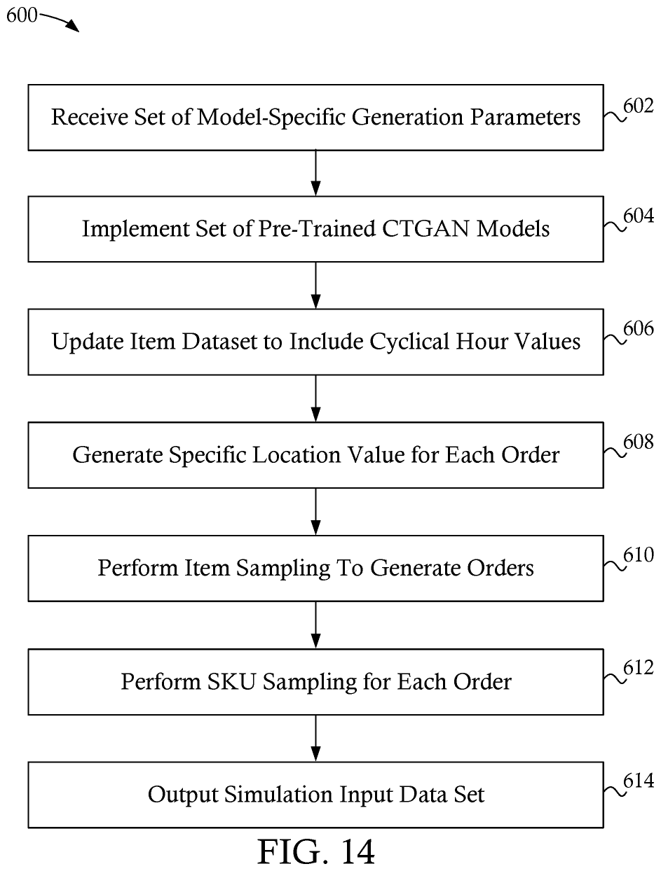

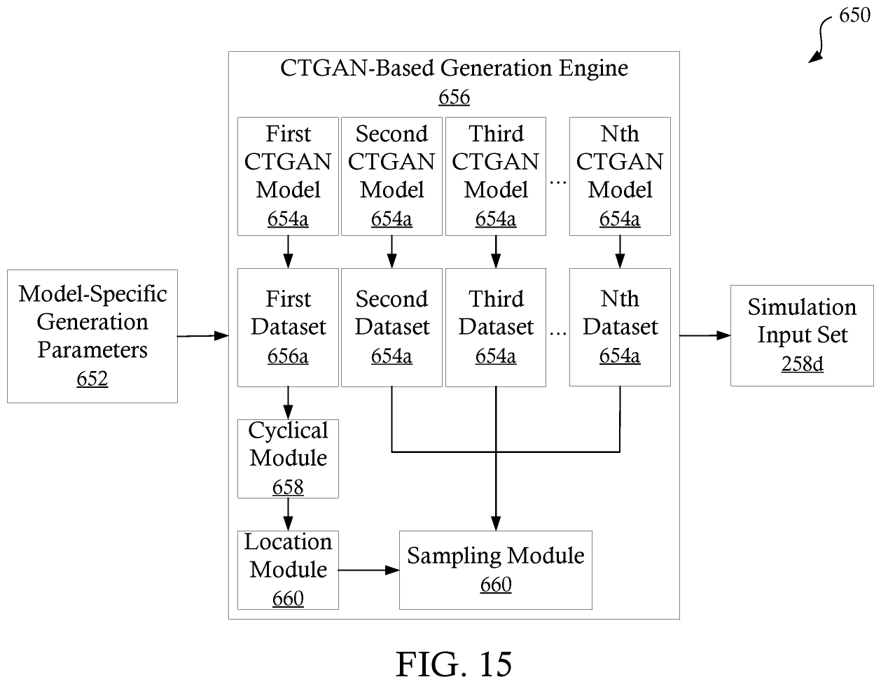

FIG. 14 illustrates a method 600 of generating simulation inputs using CTGAN modeling, in accordance with some embodiments. FIG. 15 illustrates a process flow 650 including various steps of the method 600 of generating simulation inputs using CTGAN modeling, in accordance with some embodiments. At step 602, a set of model-specific generation parameters 652 is received. The set of model-specific generation parameters 652 can include one or more parameters for configuring one of a plurality of CTGAN models 654a-654d to generate a set of simulation inputs 258d. The set of model-specific generation parameters 652 can include, but is not limited to, a time parameter (e.g., a parameter defining a date for generation of simulation inputs), a number of units to include in the output, a velocity distribution, an order mix distribution, and/or any other suitable parameters. In some embodiments, a CART model 554 can be configured to provide one or more default parameters if specific values are not provided in the set of model-specific generation parameters 552.

At step 604, a set of pre-trained CTGAN models 654a-654d are implemented. In some embodiments, the set of pre-trained CTGAN models 654a-654d are implemented by a CTGAN-based generation engine 656. Each CTGAN model 654a-654d is configured to generate a model-specific dataset 656a-656d. For example, in some embodiments, a first CTGAN model 654a is configured to generate an item dataset 656a and each of a second CTGAN model 654b, a third CTGAN model 654c, and a fourth CTGAN model 654d are each configured to generate an order SKU datasets 656b-656d for a specific order type. In some embodiments, the item dataset 656a includes items at a subcategory level and each of the order SKU datasets 656b-656d include sets of subcategory-specific SKUs (e.g., specific items).

At step 606, the item dataset 656a is updated to include normal hour values and, at step 608, the item dataset 656a is updated to include specific latitude and longitude values. For example, in some embodiments, the item dataset 656a includes cyclical time features representative of time spreads over one or more cycles (e.g., one or more recurring periods). The cyclical time features can be converted to normal hour values, e.g., values corresponding to hours of the day within a predetermined range, by a cyclical conversion module 658. The converted time values can be used to populate an order time column for orders including one or more items selected from the item dataset 656a. As another example, in some embodiments, the item dataset 656a includes latitude and longitude coordinates corresponding to randomized locations within a geographic area. The randomized locations can be converted to latitude and longitude values corresponding to known delivery locations that are close (e.g., closest) to the randomized values. In some embodiments, a trained k-dimensional (K-D) tree is configured to convert the randomized locations to known delivery locations.

At step 610, item sampling is performed to generate a plurality of orders. In some embodiments, the item dataset 656a is sampled on a per-row basis based on a sortability value generated by the first CTGAN model 654a. In some embodiments, a sortability value is representative of a number of units of a specific category in the set of units distributed across the different item categories (e.g., sort, non-sort, fresh, etc.). For each order, a number of rows as determined by the sortability value are selected and the item data for that row is incorporated into a generated order. The plurality of orders generated from the item dataset 656a are generated at a subcategory level (e.g., indicating subcategories of items in the order but not specific items).

At step 612, SKU sampling is performed for each order in the plurality of orders. SKU sampling provides SKU-level (e.g., specific items) population of an order. The SKU sampling is performed from a SKU dataset 656b-656d corresponding to the item subcategory identified for each order. For example, in some embodiments, sample subcategory rows having a nearest latitude-longitude value from each of the SKU datasets 656b-656d can be sampled based on sortability values for each row in the item dataset 656a. The sampling generates a set of orders for each subcategory of orders. In some embodiments, to generate a SKU level value, samples are obtained from a SKU catalog for each order in an order type. If the item dataset 656a includes additionally generated rows, the additional rows can be dropped to match a count of generated SKUs for the user input for each sortability type.

At step 614, a set of simulation inputs 258d is output. The set of simulation inputs 258d includes the SKU datasets 656b-656d having allocated delivery locations and populated as discussed above. In some embodiments, the set of simulation inputs 258d can include a subset of the set of SKU dataset 656b-656d. The set of simulation inputs 258d generated by the CTGAN model 650 has low fidelity as compared to the historical data collected from the system to be simulated, and can be utilized in a simulation providing coarse granularity.

With reference again to FIGS. 8 & 9, at step 308, the selected generation subsystem 354a-354d generates a set of simulation inputs 258a for execution of a simulation in a selected time frame. In some embodiments, the selected generation subsystem 354a-354d can generate a plurality of simulation input sets for the identified time period of the simulation to be performed by the simulation engine 254. The set of simulation inputs 258a generated by the hybrid input generation engine 256a can include any suitable type of inputs, such as, for example, historical sequences, stochastic sequences, etc.

With reference again to FIGS. 6 & 7, at step 208, the set of simulation inputs 258 is provided to the simulation engine 254 and, at step 210, the simulation engine 254 executes a simulation of the desired system and/or subsystem using the simulation inputs 258. The simulation engine 254 can be configured to implement any suitable simulation mechanism, algorithm, module, etc. In some embodiments, the set of simulation inputs 258 include stochastic simulation inputs and the simulation engine 254 is configured to implement a stochastic-based simulation. In embodiments including supply chain simulation, the implemented simulation can include a sourcing engine (not shown) configured to implement feature engineering to perform flow path optimization and/or constrained order allocation. In addition, the implemented simulation can be configured to simulate last mile delivery, cost calculations, and/or other costs associated with supply chain operations.

At step 212, a simulation output 270 is provided to a user. For example, in some embodiments, a simulation display interface 272 including the simulation output 270 is generated via a display. The simulation output 270 can include overall simulation results, subsystem simulation results, time-series simulation results, and/or any other suitable simulation result information. In some embodiments, the simulation output 270 includes data describing, identifying, and/or including the simulation parameters 252 and/or the set of simulation inputs 258 used to perform a simulation by the simulation engine 254.

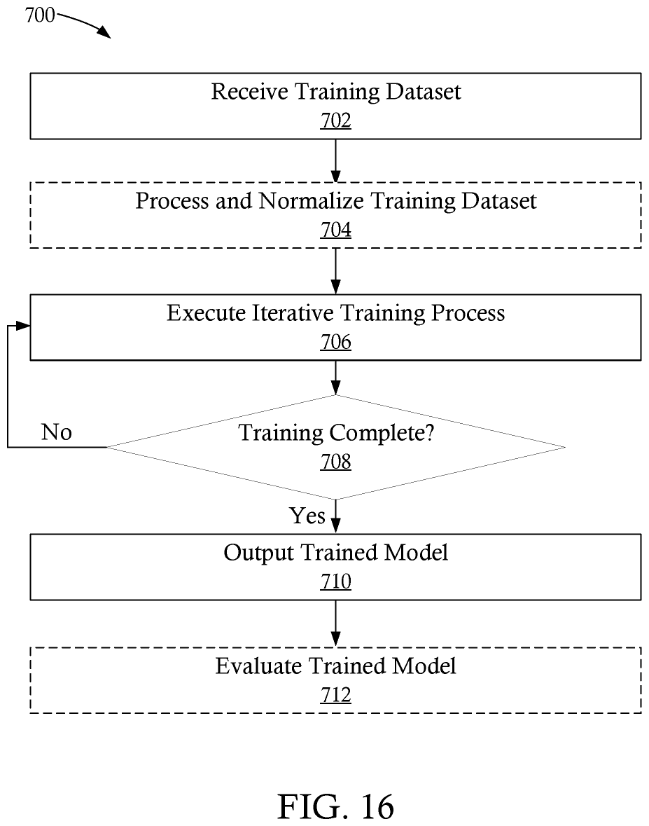

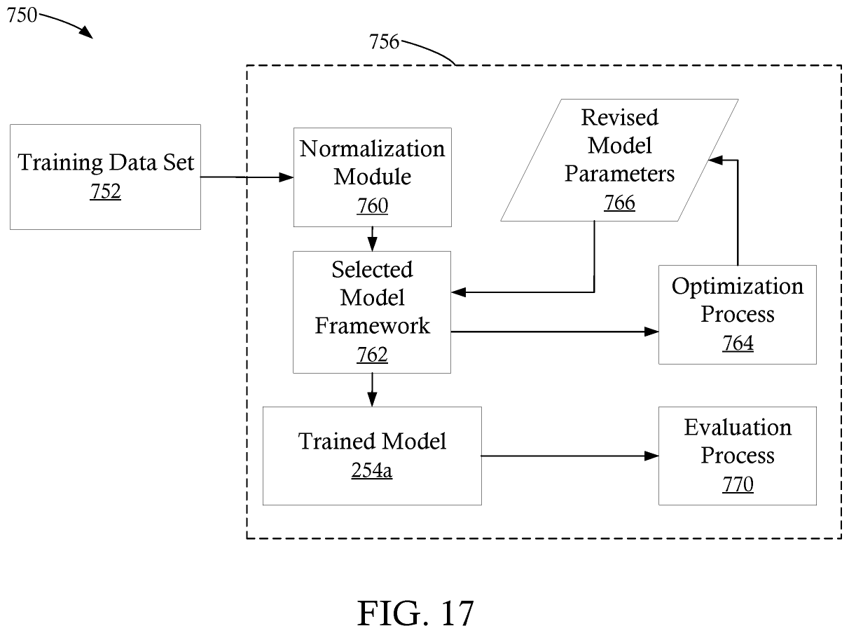

FIG. 16 illustrates a method 700 of generating a trained machine learning model, in accordance with some embodiments. FIG. 17 illustrates a process flow 750 of the method 700 of generating a trained machine learning model, in accordance with some embodiments. At 702, a training dataset 752 is received by a model training engine 756. The training dataset 752 can include labeled and/or unlabeled data. For example, in some embodiments, the training dataset 752 includes observed data from operation of a system to be simulated. The observed data can include system generated data, user generated data, third-party data, and/or any other suitable source of data. The training dataset 752 can include system outputs, metrics, achievements, and/or other measures of system operation during prior (e.g., historical) time periods. In some embodiments, the training dataset 752 includes data collected from one or more production systems 22a, 22b and/or stored in the production data store 32.

At optional step 704, the received training dataset 752 is processed and/or normalized by a normalization module 760. For example, in some embodiments, the training dataset 752 can be augmented by imputing or estimating missing values of one or more features associated with the system to be simulated. In some embodiments, processing of the received training dataset 752 includes outlier detection configured to remove data likely to skew training of a simulation input generation model. In some embodiments, processing of the received training dataset 752 includes removing features that have limited value with respect to training of the simulation input generation model, such as features that have little to no impact on variations in system operation or performance.

At step 706, an iterative training process is executed to train a selected model framework 762. The selected model framework 762 can include an untrained (e.g., base) machine learning model framework, such as a bootstrap sampling framework, a CART framework, a CTGAN framework, and/or a partially or previously trained model (e.g., a prior version of a trained simulation input generation model, a partially trained model from a prior iteration of a training process, etc.). The training process is configured to iteratively adjust parameters (e.g., hyperparameters) of the selected model framework 762 to minimize a cost value (e.g., an output of a cost function) for the selected model framework 762. In some embodiments, the cost value is related to a match between predicted behavior, e.g., simulation inputs and estimated simulation output values, and actual prior performance of the system.

The training process is an iterative process that generates set of revised model parameters 766 during each iteration. The set of revised model parameters 766 can be generated by applying an optimization process 764 to the cost function of the selected model framework 762. The optimization process 764 can be configured to reduce the cost value (e.g., reduce the output of the cost function) at each step by adjusting one or more parameters during each iteration of the training process.

After each iteration of the training process, at step 708, a determination is made whether the training process is complete. The determination at step 708 can be based on any suitable parameters. For example, in some embodiments, a training process can complete after a predetermined number of iterations. As another example, in some embodiments, a training process can complete when it is determined that the cost function of the selected model framework 762 has reached a minimum, such as a local minimum and/or a global minimum.

At step 710, a trained simulation input generation model 254a is output and provided for use in an interface generation method, such as the method 200 discussed above with respect to FIGS. 6-7. The trained simulation input generation model 254a is configured to generate a set of simulation inputs 258. At optional step 712, a trained simulation input generation model 254a can be evaluated by an evaluation process 772. Although specific embodiments are discussed herein, it will be appreciated that any suitable set of evaluation metrics can be used to evaluate a trained model.

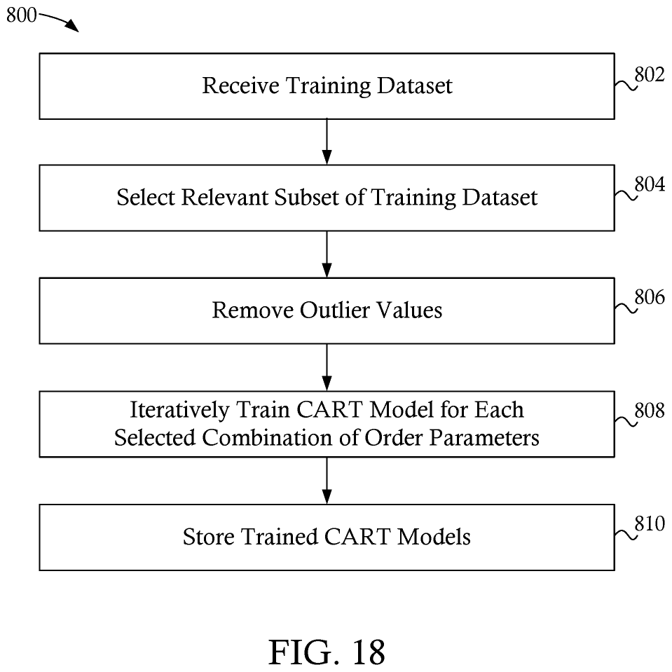

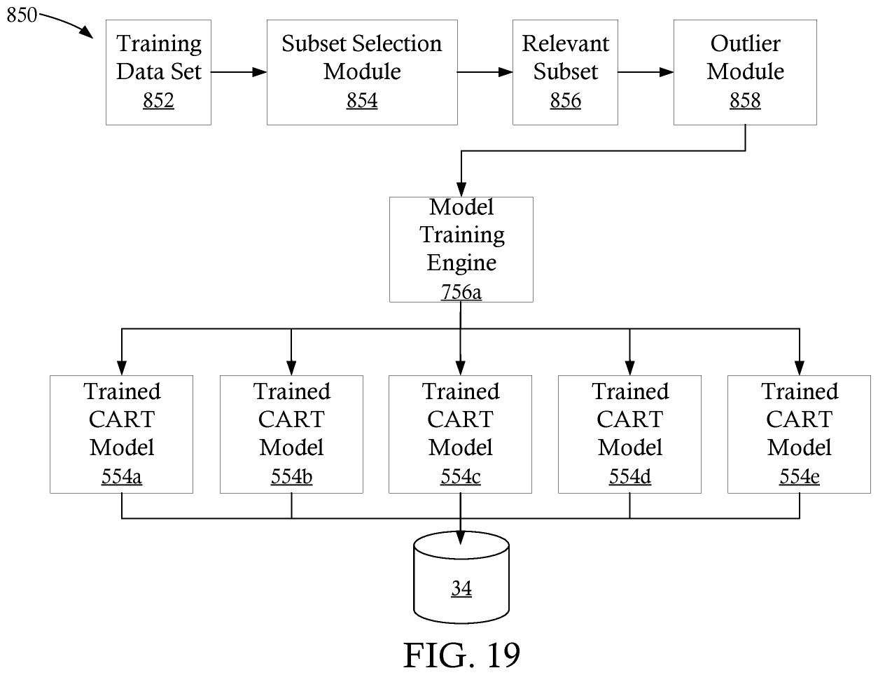

FIG. 18 is a flowchart illustrating a method 800 of generating a plurality of CART models, in accordance with some embodiments. FIG. 19 illustrates a process flow 850 of the method of generating a plurality of CART models 554a-554e, in accordance with some embodiments. At step 802, a training dataset 852 is received. The training dataset 852 can include historical data for a predetermined time period collected from and/or associated with a system to be simulated. For example, in embodiments configured to simulate a supply chain system, the training dataset 852 can include a set of order data obtained from an e-commerce platform for a predetermined time period, such as one year. Although specific embodiments are discussed herein, it will be appreciated that any suitable training dataset 852 can be provided for training CART models 554a-554e for any system to be simulated.

At step 804, a relevant subset 856 of the training dataset 852 is selected. The relevant subset 856 can include a set of selected columns having order times, weights, volumes, service level agreement values (e.g., values representative of a promised delivery time), etc. The set of selected columns can be determined by a subset selection module 854 based on time ranges, item categories, order categories, and/or any other suitable selection criteria. For example, in some embodiments, the set of selected columns includes columns associated with orders including each of a plurality of item types.

At step 806, the relevant subset 856 of the training dataset 852 is filtered to remove outlier values. For example, in some embodiments, the relevant subset 856 is filtered by a processing module 858 to remove extreme values (e.g., above/below a predetermined threshold, outside of a predetermined number of standard deviations, more than a predetermined amount above or below a mean or mode, etc.) in the weight and/or volume fields. Additional normalization and/or filtering can additionally be performed, as discussed above with respect to FIGS. 16-17.

At step 808, a plurality of CART models 554a-554e are trained by an iterative training process implemented by a model training engine 756a, as discussed above with respect to FIGS. 16-17. Each of the plurality of CART models 554a-554e can be trained for a selected combination of order parameters. For example, in some embodiments, each of the plurality of CART models 554a-554e can be trained for each item category (e.g., sort, non-sort, etc.) and velocity code (e.g., superhead, head, torso, tail, etc.) combination within the relevant subset 856. Although specific embodiments are discussed herein, it will be appreciated that any suitable set of parameters can be selected for defining each of the plurality of trained CART models 554a-554e.

At step 810, each of the trained CART models 554a-554e can be stored in a model data store 34. The trained CART models 554a-554e can be deployed from the model data store 34 to one or more systems, such as a hybrid input modeling system 28, for use in simulation input generation. For example, in some embodiments, each of the CART models 554a-554e can be deployed by a CART-based generation engine 556 as part of a CART-based method 500 for generating simulation input sets, as discussed above.

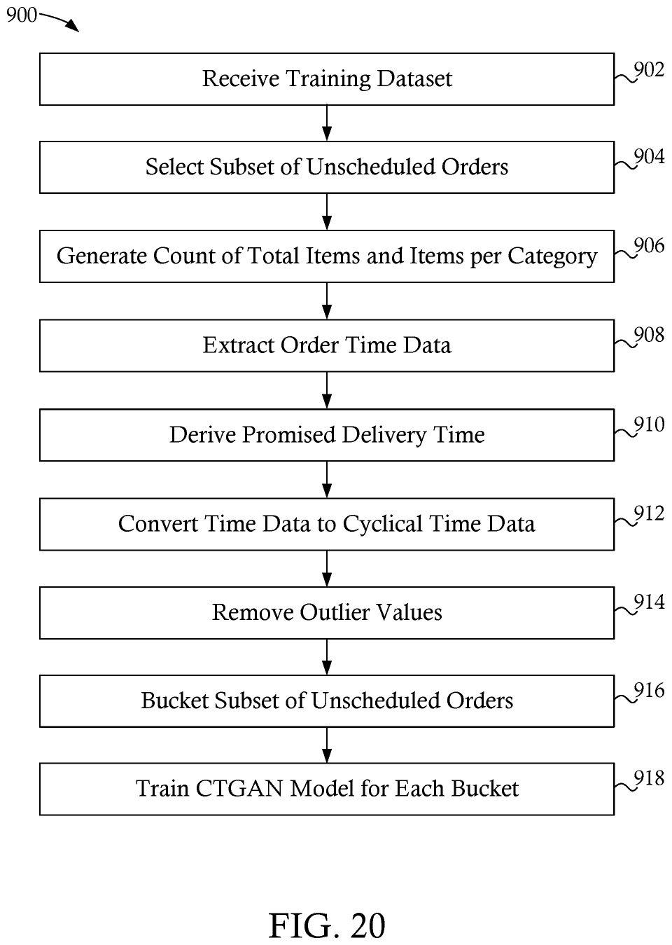

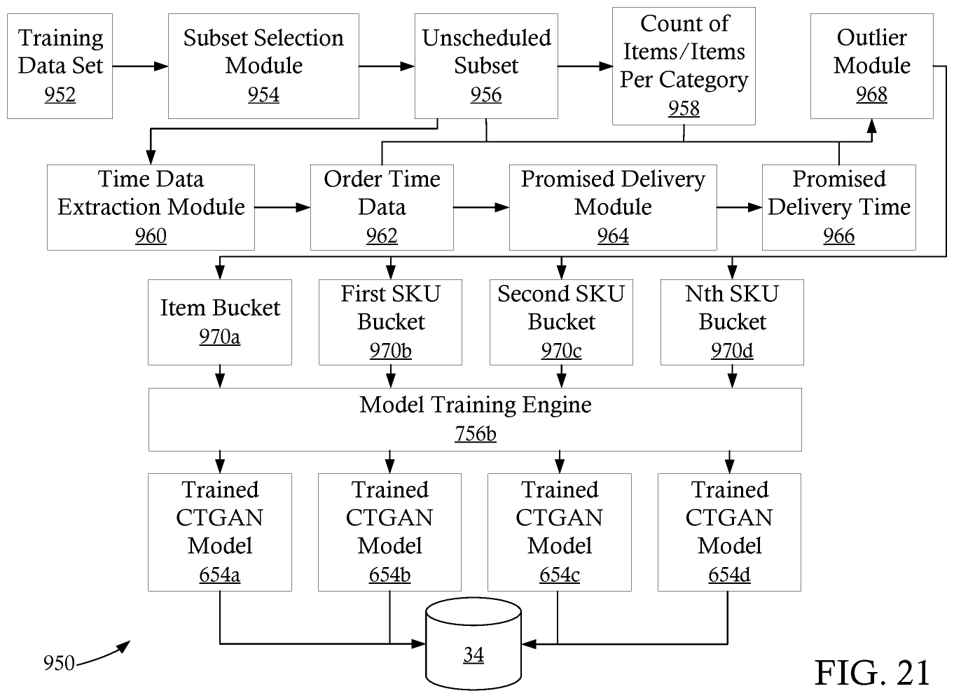

FIG. 20 is a flowchart illustrating a method 900 of generating a plurality of CTGAN models, in accordance with some embodiments. FIG. 21 is a process flow 950 illustrating various steps of the method 900 for generating a plurality of CTGAN models 654a-654d, in accordance with some embodiments. At step 902, a training dataset 952 is received. The training dataset 952 can include historical data for a predetermined time period collected from and/or associated with a system to be simulated. For example, in embodiments configured to simulate a supply chain system, the training dataset 952 can include a set of order data obtained from an e-commerce platform for a predetermined time period, such as one year. Although specific embodiments are discussed herein, it will be appreciated that any suitable training dataset 952 can be provided for training CTGAN models 654a-654d for any system to be simulated.

At step 904, a set of unscheduled orders 956 is selected from the training dataset 952. The subset of unscheduled orders 956 can be selected by a subset selection module 954 configured to filter the training dataset 952 to identify unscheduled orders. The subset of unscheduled orders 956 includes orders that were shipped without a specifically scheduled delivery time within the training dataset 952. At step 906, a count of total items and items per category 958 for each order is generated.

At step 908, order time data 962, such as month, day, hour, minute, etc. is extracted from each order in the subset of unscheduled orders 956. In some embodiments, the order time data 962 is extracted by a time data extraction module 960 from a timestamp of each order in the subset of unscheduled orders 956. In some embodiments, the order time data 962 can be obtained from a secondary database and/or derived from data associated with each order in the subset of unscheduled orders 956.

At step 910, a promised delivery time 966 is derived for each order in the subset of unscheduled orders 956. In some embodiments, the promised delivery time 966 is determined by a promised delivery module 964 based on a difference between the order time data 962, e.g., the order placed time, and an actual delivery time for each order in the subset of unscheduled orders 956. The promised delivery time 966 represents a predicted delivery period equal to the actual delivery time required for each order.

At step 912, the order time data 962 and/or the promised delivery time 966 can be converted into cyclic time variables 970. In some embodiments, a cyclical conversion module is configured to convert the extracted and/or calculated time variables from real time (e.g., providing a specific month, date, hour, minute, etc.) to cyclical variables configured to represent a cyclic nature of time values (e.g., daily cycles, weekly cycles, monthly cycles, yearly cycles, etc.). For example, in some embodiments, order time data can be converted into weekly representations based on assignment of dates to a Sunday-Saturday cyclical weekly calendar. Cyclic representation of the order time data 962 and/or the promised delivery time 966 allows a reduced dataset to be provided for model training and while allowing meaningful extraction of cyclical data features from the subset of unscheduled orders 956.

At step 914, the subset of unscheduled orders 956 is filtered to remove outlier values. For example, in some embodiments, an outlier module 968 filters the subset of unscheduled orders 956 to remove extreme values (e.g., above/below a predetermined threshold, outside of a predetermined number of standard deviations, more than a predetermined amount above or below a mean or mode, etc.) in one or more fields. For example, in some embodiments, the subset of unscheduled orders 956 can be filtered to select only orders where the number of items is less than a predetermined amount, orders where the number of purchased units is less than a predetermined amount, the calculated promised delivery time 966 is less than a predetermined threshold, etc. Additional normalization and/or filtering can additionally be performed, as discussed above with respect to FIGS. 14-15.

At step 916, the subset of unscheduled orders 956 is divided (e.g., bucketed) into a plurality of buckets 970a-970d corresponding to one or more selected categories. For example, in the illustrated embodiment, the subset of unscheduled orders 956 is bucketed into a plurality of buckets 970a-970d corresponding to item and three SKU datasets. The item bucket 970a includes order level data with a number of (e.g., types of) items in each order, order place time, and location. In some embodiments, the item bucket 970a is a plurality of rows in which each row represents details of a single order. In some embodiments, the SKU data buckets 970b-970d each include a set of SKUs for one of three different categories, e.g., sort, non-sort, fresh, and include details regarding items present in an order.

At step 918, a CTGAN model 654a-654d is generated for each bucket 964a-964d in the plurality of buckets 964a-964d. Each of the CTGAN models 654a-654d can be trained using an iterative training process, as discussed above with respect to FIGS. 16-17. As discussed above with respect to FIGS. 13-14, each of the CTGAN models 654a-654d can be deployed to generate a set of input data that can be combined to generate a finalized set of simulation input data.

At step 920, each of the trained CTGAN models 654a-654d can be stored in a model data store 34. The trained CTGAN models 654a-654d can be deployed from the model data store 34 to one or more systems, such as a hybrid input modeling system 28, for use in simulation input generation. For example, in some embodiments, each of the CTGAN models 654a-654d can be deployed by a CTGAN-based generation engine 656 as part of a CTGAN-based method 600 for generating simulation input sets, as discussed above.

Generation of simulation inputs for systems operating on large catalogs of items, such as supply chains for large retailers, can require simulation of millions of individual items. Dimensions for each item in a catalog is an essential input for simulating certain systems. However, in typical catalogs, not all of the included items have easily extractable dimensions (e.g., missing dimensions, poorly characterized dimensions, etc.). One approach to identify missing dimensions for a first item is to identify a similar item in similar grouping (e.g., subcategories) that includes the necessary dimensions and estimate missing dimensions of the first item based on values for the second item. Similar items can be identified using any suitable techniques, such as natural language processing techniques including entity extraction, term frequency-inverse document frequency (TF IDF), etc. However, large datasets can make such processes unwieldy.

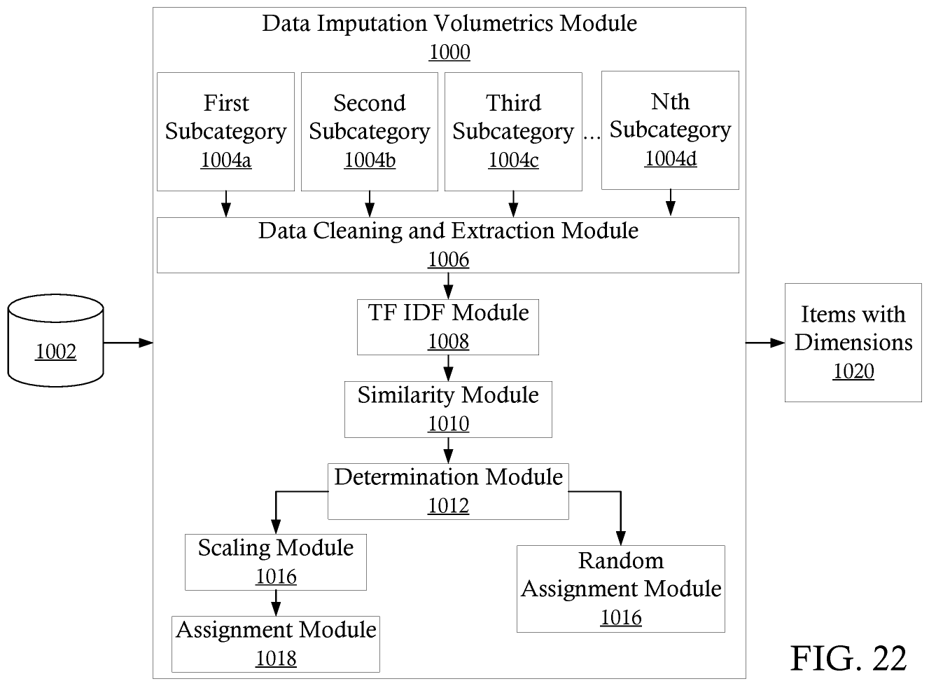

FIG. 22 illustrates a data imputation volumetrics module 1000, in accordance with some embodiments. The data imputation volumetrics module 1000 is configured to handle dimension imputation for large catalogs of items. The data imputation volumetrics module 1000 is configured to split all of the items (e.g., SKUs, item identifiers, etc.) in an item database 1002 into a plurality of subcategories 1004a-1004d. Each of the subcategories 1004a-1004d is determined based on hierarchical and/or other meta information for each item in the item database 1002. In some embodiments, the plurality of subcategories 1004a-1004d can include thousands of subcategories based on the hierarchical and/or other meta information.

For each subcategory 1004a-1004d, the data imputation volumetrics module 1000 is configured to extract each item, e.g., each SKU, in the subcategory and provide each item to a data cleaning and extraction module 1006. Data cleaning can include, but is not limited to, normalization of item data, removal of outlier data, etc. In some embodiments, entity extraction is performed on the item product name using one or more extraction mechanisms, such as, for example, quantulum3. The cleaned corpus of items is provided to a TF IDF module 1008 configured to vectorize the cleaned corpus of items to generate vectors for each item name in the subcategory.

The generated vectors are provided to a similarity module 1010. For each item missing a dimension, the similarity module 1010 is configured to identify a set of closest items within the subcategory based on the generated vectors. In some embodiments, the similarity module 1010 applies a cosine similarity process to the generated vectors. The set of closest items can include any number of items, such as, for example, four. In some embodiments, a maximum similarity score is determined for each of the items in the set of closest items.

A determination module 1012 determines if the maximum similarity score for the set of closest items is above a predetermined threshold. For example, in some embodiments, the predetermined threshold is 0.25, although it will be appreciated that any suitable similarity threshold can be used. If the determination module 1012 determines the maximum similarity score is below (or, in embodiments, equal to) a predetermined threshold, a random assignment module 1014 assigns a random dimension within a predetermined range for the given subcategory. For example, in some embodiments, a the random assignment module 1014 assigns a value between 0.2 quantile and 0.8 quantile for the current subcategory. Although specific embodiments are discussed herein, it will be appreciated that any suitable values can be assigned.

If the determination module 1012 determines the maximum similarity is above (or, in some embodiments, equal to) the predetermined threshold, the dimensions for each item in the set of closest items is scaled by a scaling module 1016 to similar measurement units and a mean value of the set of closest items is calculated and assigned as the dimension value for the selected SKU by an assignment module 1018. Although specific embodiments are discussed herein, it will be appreciated that any suitable process can be used to generate necessary catalog data for use in the disclosed simulation methods. The data imputation volumetrics module 1000 is configured to output a set of items with completed dimensions 1020 based on the random and/or scaling assignment of dimension values for each item.

Although the subject matter has been described in terms of exemplary embodiments, it is not limited thereto. Rather, the appended claims should be construed broadly, to include other variants and embodiments, which can be made by those skilled in the art.

What is claimed is:

1. A system configured to simulate a target system, comprising:
a non-transitory memory;
a processor communicatively coupled to the non-transitory memory, wherein the processor is configured to read a set of instructions to:
receive a set of input generation parameters;
determine a simulation time period for a simulation of the target system based on the set of input generation parameters, wherein the simulation time period is one of a plurality of defined time periods;
select one of a plurality of input generation subsystems for the simulation time period, wherein each of the plurality of input generation subsystems is configured to generate a set of simulation inputs for one of the plurality of defined time periods, wherein at least one of the plurality of input generation subsystems is configured to generate a stochastic set of simulation inputs;
generate the set of simulation inputs by implementing a input generation process defined by the selected one of the plurality of input generation subsystems; and
implement the simulation of the target system based on the set of simulation inputs.

2. The system of claim 1, wherein the input generation process of the selected one of the plurality of input generation subsystems comprises a bootstrap sampling process.

3. The system of claim 2, wherein the input generation process is configured to generate the set of simulation inputs by:
determining an order type distribution
determining a demand distribution for each of a plurality of item types;
generating a demand for each item type in the plurality of item types for each of a plurality of orders;
sampling a leftover demand;
assigning a specific location value within a predetermined area to each order in the plurality of orders; and
combining the demand and the leftover demand to generate the set of simulation inputs.

4. The system of claim 1, wherein the input generation process of the selected one of the plurality of input generation subsystems comprises a classification and regression tree-based process.

5. The system of claim 4, wherein the input generation process is configured to generate the set of simulation inputs by:
determining demand units for each order mix type in a plurality of orders;
modifying demand units to balance each order mix type in the plurality of orders;
generating, by at least one classification and regression tree model, a set of item units;
allocating one or more items in the set of item units to the plurality of orders;
assigning a specific location value within a predetermined area to each order in the plurality of orders; and
outputting the plurality of orders including the allocated one or more items and the specific location value.

6. The system of claim 1, wherein the input generation process of the selected one of the plurality of input generation subsystems comprises a conditional tabular generative adversarial network-based process.

7. The system of claim 6, wherein the input generation process is configured to generate the set of simulation inputs by:
generating, by a first conditional tabular generative adversarial network model, an item dataset including a plurality of rows defining an item by a subcategory level;
converting time values in the item dataset to cyclical variables;
assigning a specific location value within a predetermined area to each item in the plurality of items;
generating a plurality of orders by selecting one or more of the a plurality of rows from the item dataset according to a sortability value;
generating, by one or more second conditional tabular generative adversarial network models, a plurality of subcategory datasets each defining a plurality of items within an associated subcategory level;
modifying each order in the plurality of orders to include specific items by sampling the plurality of items for a selected one of the plurality of subcategory datasets corresponding to the subcategory level of each row in the order; and
outputting the plurality of orders.

8. The system of claim 1, wherein, prior to generating the set of simulation inputs, the processor is configured to impute dimensions for each item in a catalog of items, wherein the set of simulation inputs is generated based on the catalog of items.

9. A computer-implemented method, comprising:
receiving a set of input generation parameters;
determining a simulation time period for a simulation of a target system based on the set of input generation parameters, wherein the simulation time period is one of a plurality of defined time periods;
selecting one of a plurality of input generation subsystems for the simulation time period, wherein each of the plurality of input generation subsystems is configured to generate a set of simulation inputs for one of the plurality of defined time periods, wherein at least one of the plurality of input generation subsystems is configured to generate a stochastic set of simulation inputs;
generating the set of simulation inputs by implementing a input generation process defined by the selected one of the plurality of input generation subsystems; and
implementing a statistical simulation of the target system based on the set of simulation inputs.

10. The computer-implemented method of claim 9, wherein the input generation process of the selected one of the plurality of input generation subsystems comprises a bootstrap sampling process.

11. The computer-implemented method of claim 10, wherein the input generation process is configured to generate the set of simulation inputs by:
determining an order type distribution
determining a demand distribution for each of a plurality of item types;
generating a demand for each item type in the plurality of item types for each of a plurality of orders;
sampling a leftover demand;
assigning a specific location value within a predetermined area to each order in the plurality of orders; and
combining the demand and the leftover demand to generate the set of simulation inputs.

12. The computer-implemented method of claim 9, wherein the input generation process of the selected one of the plurality of input generation subsystems comprises a classification and regression tree-based process.

13. The computer-implemented method of claim 12, wherein the input generation process is configured to generate the set of simulation inputs by:
determining demand units for each order mix type in a plurality of orders;
modifying demand units to balance each order mix type in the plurality of orders;
generating, by at least one classification and regression tree model, a set of item units;
allocating one or more items in the set of item units to the plurality of orders;
assigning a specific location value within a predetermined area to each order in the plurality of orders; and
outputting the plurality of orders including the allocated one or more items and the specific location value.

14. The computer-implemented method of claim 9, wherein the input generation process of the selected one of the plurality of input generation subsystems comprises a conditional tabular generative adversarial network-based process.

15. The computer-implemented method of claim 14, wherein the input generation process is configured to generate the set of simulation inputs by:
generating, by a first conditional tabular generative adversarial network model, an item dataset including a plurality of rows defining an item by a subcategory level;
converting time values in the item dataset to cyclical variables;
assigning a specific location value within a predetermined area to each item in the plurality of items;
generating a plurality of orders by selecting one or more of the a plurality of rows from the item dataset according to a sortability value;
generating, by one or more second conditional tabular generative adversarial network models, a plurality of subcategory datasets each defining a plurality of items within an associated subcategory level;
modifying each order in the plurality of orders to include specific items by sampling the plurality of items for a selected one of the plurality of subcategory datasets corresponding to the subcategory level of each row in the order; and
outputting the plurality of orders.

16. The computer-implemented method of claim 15, comprising, prior to generating the item dataset, training the first conditional tabular generative adversarial network model and the one or more second conditional tabular generative adversarial network models based a set of unscheduled orders selected from historical data associated with the target system.

17. A non-transitory computer-readable medium having instructions stored thereon that, when executed by a processor, cause a device to perform operations comprising:
receiving a set of input generation parameters;
determining a simulation time period for a simulation of a target system based on the set of input generation parameters, wherein the simulation time period is one of a plurality of defined time periods;
selecting one of a plurality of input generation subsystems for the simulation time period, wherein each of the plurality of input generation subsystems is configured to generate a set of simulation inputs for one of the plurality of defined time periods, wherein at least one of the plurality of input generation subsystems is configured to generate a stochastic set of simulation inputs, and wherein the plurality of input generation subsystems comprise a historical sampling subsystem, a bootstrap sampling subsystem, a classification and regression tree subsystem, and a conditional tabular generative adversarial network;
generating the set of simulation inputs by implementing a input generation process defined by the selected one of the plurality of input generation subsystems; and
implementing a statistical simulation of the target system based on the set of simulation inputs.

18. The non-transitory computer-readable medium of claim 17, wherein the historical sampling subsystem is associated with a first time period, the bootstrap sampling subsystem and the classification and regression tree subsystem are each associated with a second time period, and the conditional tabular generative adversarial network is associated with a third time period.

19. The non-transitory computer-readable medium of claim 17, wherein selecting the one of the plurality of input generation subsystems includes:
selecting a first subset of input generation subsystems for the time period; and
determining a granularity for the simulation based on the set of input generation parameters; and
selecting the one of the plurality of input generation subsystems from the first subset of input generation subsystems based on the granularity.

20. The non-transitory computer-readable medium of claim 19, wherein the historical sampling subsystem is associated with a first granularity of the simulation of the target system, the bootstrap sampling subsystem is associated with a second granularity, the classification and regression tree subsystem is associated with a third granularity, and the conditional tabular generative adversarial network is associated with a fourth granularity.
